(19) United States
(12) Patent Application Publication
(10) Pub. No.: US 2026/0087401 A1
(43) Pub. Date: Mar. 26, 2026

(54) AUTOMATED VALIDATION AND BENCHMARKING OF PARAMETERIZABLE MODELS IN DISTRIBUTED COMPUTING ENVIRONMENTS

(71) Applicant: NVIDIA Corporation, Santa Clara, CA (US)

(72) Inventors: Benjamin NAUJOKS, Neubiberg (DE); Viacheslav Bolnykh, Berlin (DE); Ayman Elsaeid, Berlin (DE); Marius Montebaur, Berlin (DE)

(21) Appl. No.: 18/891,952

(22) Filed: Sep. 20, 2024

(51) Int. Cl. G06N 20/00

(52) U.S. Cl. CPC G06N 20/00

(57) ABSTRACT

Embodiments of the present disclosure relate to automated optimization and/or evaluation of parameterizable models. With respect to optimization, some embodiments record or collect data according to a user instruction during the optimization of the parameterizable model. Based on such recording or collection, some embodiments then update a parameter during optimization, such as via local and/or global optimization. With respect to evaluation, some embodiments perform validation and/or benchmarking based on a type of parameterizable model and one or more performance metrics. Some embodiments perform local validation and/or global validation as part of the validation and/or benchmarking.

### CROSS-REFERENCE TO RELATED APPLICATIONS

This application is related to U.S. Patent Application No. TBD, entitled “Automated Optimization of Parameterizable Models in Distributed Computing Environments,” filed on Sep. 20, 2024.

### BACKGROUND

A parameterizable model is a mathematical or computational model that contains parameters that can be adjusted or customized to fit specific data or conditions. These parameters are variables within the model that govern its behavior or output, and they can be tuned or modified to better represent the underlying phenomena being modeled. Examples of parameterizable models include statistical models (e.g., regression models) where parameters like coefficients can be adjusted to fit data, machine learning models (e.g., neural networks) where parameters like weights and biases can be tuned during training, sensor models (e.g., radar models), where parameters like beam spread, minimum power thresholds, antenna gain, etc. can be optimized, and physical models (e.g., models of physical systems, such as mechanical systems, electrical circuits, etc.), where parameters like mass, velocity, and resistance can be adjusted based on experimental data).

Parameterizable models strive to find an optimal set of parameters (e.g., hyperparameter tuning or training) to enhance their performance and effectiveness in capturing the underlying patterns or relationships in the data they are applied to. This process may involve trying out different combinations of parameter values, and selecting the best-performing set of parameters. However, finding an optimal set of parameters is not only time consuming, but computationally expensive. Further, there are multiple objectives or criteria for optimization, such as real-time operation, model fidelity, computational efficiency, etc. Optimizing a model to meet all these targets simultaneously can increase the complexity of the optimization problem and make it more challenging to find an optimal solution.

Parameterizable models also need to be evaluated (e.g., validated) to ensure that they generalize well to unseen data and to assess their performance under different conditions. Validation, for example, refers to the process of evaluating the model's performance on a separate dataset, distinct from the one used for parameter optimization to estimate how well the model will perform on new, unseen data. For example, validation techniques can measure the accuracy of a model (e.g., classification accuracy), measure how well the model's predictions (e.g., intensity and range) align with actual measurements, and/or compare statistical quantities (e.g., various distributions). However, existing validation techniques are also not only time consuming, but they are also challenging to implement, particularly in distributed computing environments. For example, parameterizable models may operate on large datasets or require significant computational resources to orchestrate and validate.

### SUMMARY

Embodiments of the present disclosure relate to automated optimization and/or evaluation (e.g., validation and/or benchmarking) of parameterizable models—in particular, the parameterizable models used in distributed (e.g., cloud-hosted) computing platforms, and/or for generating simulations of scenarios. With respect to optimization, some embodiments first receive a user instruction that defines a sequence of actions associated with optimization of a parameterizable model. For example, such user instruction may be indicative of a web user interface selection or a command line interface command to collect or record data for the optimization of the parameterizable model (e.g., a command to collect virtual Light Detection and Ranging (LIDAR) sensor data every 10 meters as a virtual vehicle traverses through an environment). In response to receiving such user instruction, some embodiments then actually record or collect data for the optimization of the parameterizable model. Based on such recording or collection, some embodiments then update a parameter during optimization. For example, using the illustration above, initially one or more of the weights and biases (representative of the “parameter” in this example) of the virtual LIDAR neural network sensor model are initialized to random values or using specific initialization techniques. The virtual LIDAR sensor model then continuously collects sensor data by simulating the behavior of a real LIDAR sensor according to the user instruction.

In some embodiments such optimization or update of parameters includes local optimization. “Local optimization” refers to the process of optimizing one or more parameters of a model on an individual compute node (e.g., a cloud instance, virtual machine, or mainframe) or client within the distributed computing environment of other compute nodes. In some embodiments, such local optimization may be performed locally on each compute node based on a subset of data, and the results are aggregated at a central server for further processing, as described in more detail below.

In some embodiments, the optimization or update of parameters additionally or alternatively includes global optimization. “Global optimization” refers to the process of aggregating optimization results from multiple nodes or clients in the distributed computing environment to determine the best overall set of parameters for the model being optimized. Accordingly, after each client node conducts local optimization, the server performs global optimization by collecting the results from all nodes, aggregating them, and selecting the best (e.g., mean) parameter set. This aggregated result is then communicated back to all nodes to guide further optimization iterations.

With respect to evaluation, some embodiments perform validation and/or benchmarking based on a type of parameterizable model and one or more evaluation performance metrics (e.g., Key Performance Indicators (KPIs)). For example, some embodiments first receive user input that specifies a type of parameterizable model. In an illustrative example, a user may select a user interface element corresponding to a type of tree-based model, sensor model, Support Vector Machine (SVM), or the like. Based on the user input that specifies the type parameterizable model, some embodiments then calculate one or more performance metrics (e.g., KPIs). The type of parameterizable model can influence which KPIs are more appropriate to use based on various factors such as the model's inherent characteristics, the nature of the problem being solved, and the desired outcomes. And based at least on calculating the one or more performance metrics and the user input that specifies the type parameterizable model, some embodiments then perform validation or benchmarking of the parameterizable model.

Some embodiments perform “local validation” as part of the validation and/or benchmarking. “Local validation” refers to the process of validating and/or benchmarking model on an individual compute node or client within the distributed computing environment of multiple compute nodes or clients. This validation and/or benchmarking may be performed locally on each node based on a subset of data, and the results are aggregated at a central server for further processing.

In some embodiments, the benchmarking and/or validating a model additionally or alternatively includes global validation. “Global validation” refers to the process of aggregating validation and/or benchmarking results from multiple nodes or clients in the distributed environment. That is, data from multiple nodes are aggregated and validated/benchmarked collectively on a central server or other node. Accordingly, after each client node conducts local validation, the server performs global optimization by collecting the results from all nodes and aggregating them.

### BRIEF DESCRIPTION OF THE DRAWINGS

The present systems and methods for sensor simulation and learning sensor models with generative machine learning is described in detail below with reference to the attached drawing figures, wherein:

FIG. 1 is an example pipeline for automatically optimizing and evaluating a parameterizable model, in accordance with some embodiments of the present disclosure;

FIG. 2 is a block diagram illustrating how different tasks are performed via local and global optimization and evaluation, in accordance with some embodiments of the present disclosure;

FIG. 3 is a block diagram of a distributed system architecture, in accordance with some embodiments of the present disclosure;

FIG. 4 is a sequence diagram illustrating how a user device, server, and client compute nodes work together to perform local and global optimization, in accordance with some embodiments of the present disclosure;

FIG. 5 is a sequence diagram illustrating how a user device, server, and client compute nodes work together to perform local and global evaluation (benchmarking and/or validation), in accordance with some embodiments of the present disclosure;

FIG. 6 is a flow diagram of an example method for optimizing a parameterizable, model, in accordance with some embodiments of the present disclosure;

FIG. 7 is a flow diagram of an example method for validating and/or benchmarking a parameterizable model, in accordance with some embodiments of the present disclosure;

FIG. 8 illustrates a visualization of KPI values and parameter values over optimization iterations, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Some embodiments relate to automated optimization and/or evaluation (e.g., validation and/or benchmarking) of parameterizable models. With respect to optimization, some embodiments first receive a user instruction that defines a sequence of actions associated with optimization of a parameterizable model. For example, such user instruction may be indicative of a web user interface selection or a command line interface command to collect or record data for the optimization of the parameterizable model. In an illustrative example, the user instruction may be a command to collect virtual Light Detection and Ranging (LIDAR) sensor data every 10 meters as a virtual vehicle (or other ego-machine) traverses through an environment. Another action of the user instruction may be to move the target distance of when data is collected from 10 meters to 20 meters such that measurements at different distances occur.

In response to receiving such user instruction, some embodiments then actually record or collect data during the optimization of the parameterizable model. For example, using the illustration above, some embodiments actually collect the virtual sensor model data first at 10 meters and then at 20 meters. Based on such recording or collection, some embodiments then update a parameter during optimization. For example, using the illustration above, initially one or more of the weights and biases (representative of the “parameter” in this example) of the virtual LIDAR neural network sensor model are initialized to random values or using specific initialization techniques. The virtual LIDAR sensor model then continuously collects sensor data by simulating the behavior of a real LIDAR sensor according to the user instruction.

The collected sensor data may be fed into the model for prediction. Continuing with this example, the model uses the current weights and biases to make predictions about the environment based on the input sensor data. The model's predictions may then be compared to ground truth or expected outcomes. The error between the predicted values and the virtual sensor data may then be calculated using a loss function (e.g., mean squared error (“MSE”)). In some embodiments, the gradient of the loss function with respect to the model's parameters (e.g., its weights and biases) is computed. This gradient represents the direction and magnitude of change needed to reduce the error. The weights and biases may then be updated using an optimization algorithm (e.g., gradient descent). Such update function adjusts the parameters in a direction that minimizes the loss function, based on the computed gradients. For example, in gradient descent, the weights and biases are updated by subtracting a fraction of the gradient from their current values, scaled by a learning rate hyperparameter. This process of data collection (according to the user instruction), prediction, error calculation, gradient computation, and parameter update continues continuously as the virtual LIDAR sensor model collects more data. With each iteration, the model's weights and biases are refined to better capture the underlying patterns in the sensor data and improve the accuracy of predictions.

In some embodiments such optimization or update of parameters includes local optimization. “Local optimization” refers to the process of optimizing one or more parameters of a model on an individual compute node (e.g., a back-end server or cloud compute node) or client within the distributed computing environment of other compute nodes. In some embodiments, such local optimization may be performed locally on each compute node based on a subset of data, and the results are aggregated at a central server for further processing, as described in more detail below. In some embodiments, each node has a copy of the same model, where parameters may be different. Multiple tasks can run on one node, or multiple nodes can be involved in one task. In some embodiments, a task corresponds to one local optimizer or global optimizer.

In some embodiments, local optimization includes calculating one or more performance metrics (e.g., Key Performance Indicators (KPI)) and then transmitting them and the updated parameter to another compute node (e.g., in preparation for global optimization, as described below). In an illustrative example, a client app may be a software application running on a smartphone that controls a drone equipped with a camera for aerial photography. The model parameter could be the exposure time of the camera.

When the client app receives a signal to start a scenario step (e.g., capturing images during a flight) from the user instruction, it may update the exposure time parameter of the camera to optimize image quality for the current lighting conditions. The model task, running on the drone's onboard computer, may then receive the signal from the client app to start capturing images. It begins the scenario step by activating the camera and capturing images of the landscape below. After completing the image capture, the model task processes the recorded images and communicates the data format (e.g., image resolution, file format) to the client app. It may also set a flag indicating that the recording is complete. The local optimizer in the client app may then evaluate the image quality metrics (KPI) of the captured images based on factors like brightness, sharpness, and contrast. It may then adjust the exposure time parameter of the camera to optimize these metrics for future image captures. The client app may then send log data containing the calculated KPI values and updated parameter settings to a server app for further analysis and monitoring. This allows for real-time tracking of optimization progress. Such optimization process may continue iteratively, with the client app and model task repeating the steps described above for a predetermined number of optimization steps or until a specified optimization tolerance level is reached.

In some embodiments, the optimization or update of parameters additionally or alternatively includes global optimization. “Global optimization” refers to the process of aggregating optimization results from multiple nodes or clients in the distributed environment to determine the best overall set of parameters for the model being optimized. Accordingly, after each client node conducts local optimization, the server performs global optimization by collecting the results from all nodes, aggregating them, and selecting the best (e.g., mean) parameter set. This aggregated result is then communicated back to all nodes to guide further optimization iterations. In some embodiments, each local node receives the same best parameter set (e.g., a mean-like strategy). In other embodiments, each local node receives a new or distinct parameter calculated from the aggregated results. In some embodiments global optimization also includes a global optimization strategy to optimally trigger new local optimization steps. For example, a Basin Hopping style optimization strategy may be used. Basin Hopping is a global optimization algorithm used for finding the global minimum of a function, which can be especially useful for problems with many local minima. The method combines local optimization with a random search of the solution space, allowing it to escape local minima and explore the global landscape more effectively.

Such global optimization may include federated learning in some embodiments. “Federated learning” includes training a machine learning model across multiple decentralized devices or servers holding local data samples, without exchanging them centrally. Instead of sending raw data to a central server, local models are trained locally, and only model updates (e.g., gradients) are exchanged with a central server or among other nodes. This approach ensures privacy and data security, as sensitive data remains on the local device or server.

In some embodiments, global optimization includes the following operations. Each compute node, of multiple compute nodes, may transmit, to a first compute node (e.g., a central server) its updated parameter. Embodiments may then change one or more of these parameters based at least on the first compute node having aggregated parameter values from all of the compute nodes. In an illustrative example, each node may send its learning rate (also referred to as a “model rate”) and/or updated weights to a central server. The central server may then aggregate each of the updated parameter values from each compute node by, for example, calculating the mean of each weights/learning rates received. The central server may then send the mean to all the other compute nodes, which acts as a new starting point (e.g., for another epoch/round of training).

Some embodiments additionally or alternatively evaluate the parameterizable model by validating and/or benchmarking the parameterizable model. “Benchmarking” refers to comparing or evaluating the performance (e.g., accuracy) of the parameterizable model against a standard or reference point (i.e., a “benchmark”). The purpose of using benchmarks is to provide a baseline for evaluating the performance of models. In an illustrative example, with respect Natural Language Processing (NLP) models, some embodiments may evaluate the model's performance against standard NLP benchmarks like the Stanford Sentiment Treebank (sentiment analysis), SQUAD (question answering), or GLUE (General Language Understanding Evaluation).

Some embodiments perform validation and/or benchmarking based on a type of parameterizable model and one or more performance metrics. For example, some embodiments first receive user input that specifies a type of parameterizable model. In an illustrative example, a user may select a user interface element corresponding to a type of tree-based model, sensor model, Support Vector Machine (SVM), neural network, ensemble method, Markov model, Bayesian model, or the like. Based on the user input that specifies the type parameterizable model, some embodiments then calculate one or more performance metrics (e.g., KPIs). The type of parameterizable model can influence which KPIs are more appropriate to use based on various factors such as the model's inherent characteristics, the nature of the problem being solved, and the desired outcomes. For example, a data structure having a key-value pair (e.g., a lookup table or hash map) may include keys indicating the model type and corresponding values indicating the particular KPIs. For instance, linear models (e.g., Linear Regression, Logistic Regression) may be indicated as keys and because these models are often used for regression or binary classification tasks, KPIs such as Mean Absolute Error (MAE), Mean Squared Error (MSE), and/or R-squared (R2) may be listed as values in the same entry or record. Accordingly, for example, some embodiments take the user input specifying model type as input to lookup (e.g., via fuzzy matching) the corresponding key indicating model type in order to return the KPIs that need to be performed. And based at least on calculating the one or more performance metrics and the user input that specifies the type parameterizable model, some embodiments then perform validation or benchmarking of the parameterizable model.

Some embodiments perform “local validation” as part of the validation and/or benchmarking. “Local validation” refers to the process of validating and/or benchmarking model on an individual compute node or client within the distributed computing environment of multiple compute nodes or clients. Similar to local optimization, this validation and/or benchmarking may be performed locally on each node based on a subset of data, and the results are aggregated at a central server for further processing, as described in more detail below.

In some embodiments, local validation and/or benchmarking includes the following operations. The user input described above may further define a sequence of actions representing a collection or recording task associated with the validation and/or benchmarking. Based at least on the user input that defines the sequence of actions, some embodiments record or collect data. Using the illustration above, for example, the user input may include a command to collect virtual Light Detection and Ranging (LIDAR) sensor data every 10 meters as a virtual vehicle (or other ego-machine) traverses through an environment. Based at least in part on the calculating the one or more performance metrics and recording or collecting the data according to the user input some embodiments then, transmit, to a first compute node of multiple compute nodes, the one or more performance metrics (e.g., and/or updated parameters for optimization in preparation for global validation, as described in more detail below).

In some embodiments, the benchmarking and/or validating a model additionally or alternatively includes global validation. “Global validation” refers to the process of aggregating validation and/or benchmarking results from multiple nodes or clients in the distributed environment. That is, data from multiple nodes are aggregated and validated/benchmarked collectively on a central server or other node. Accordingly, after each client node conducts local validation, the server performs global optimization by collecting the results from all nodes and aggregating them.

Accordingly, for instance, in response to a validation or benchmarking of a parameterizable model at a first node, the first node transmits, to a second compute node (e.g., a central server) the one or more performance metrics so that the second node may perform global validation based at least on the second compute node having aggregated performance metrics from all the other compute nodes in the distributed environment. For example, every node in the disturbed environment may validate a different KPI and/or scenario (e.g., as defined in the user input). The central server may then receive these different KPIs from all the nodes and then the central server may responsively aggregate the results (e.g., by wrapping all the results in a report and/or generating overall statistics about the quality of the aggregated dataset). In other words, each compute node may have its own model that needs to be validated/benchmarked. Because each model (even though it may be the same type of model) on each compute nodes may have different KPIs, input data, output data, and/or parameters, its validation and/or benchmarking scores may be different and so it may be useful to determine how the model performs using different KPIs, or other data. This validation process could involve checking for consistency, accuracy, completeness, or any other criteria relevant to the data's integrity and quality.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, with language models such as large language models (LLMs) or vision language models (VLMs), cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) or one or more vision language models (VLMs), systems for performing light transport simulation, systems for performing collaborative content creation for 3D assets, systems implemented at least partially using cloud computing resources, and/or other types of systems.

### Example Pipeline

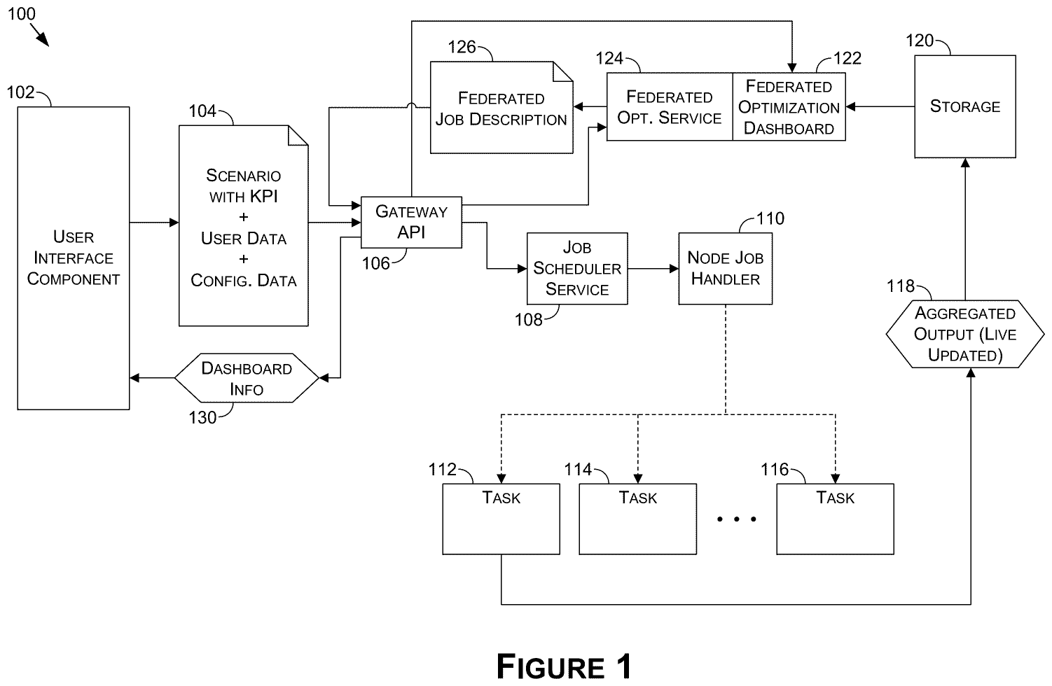

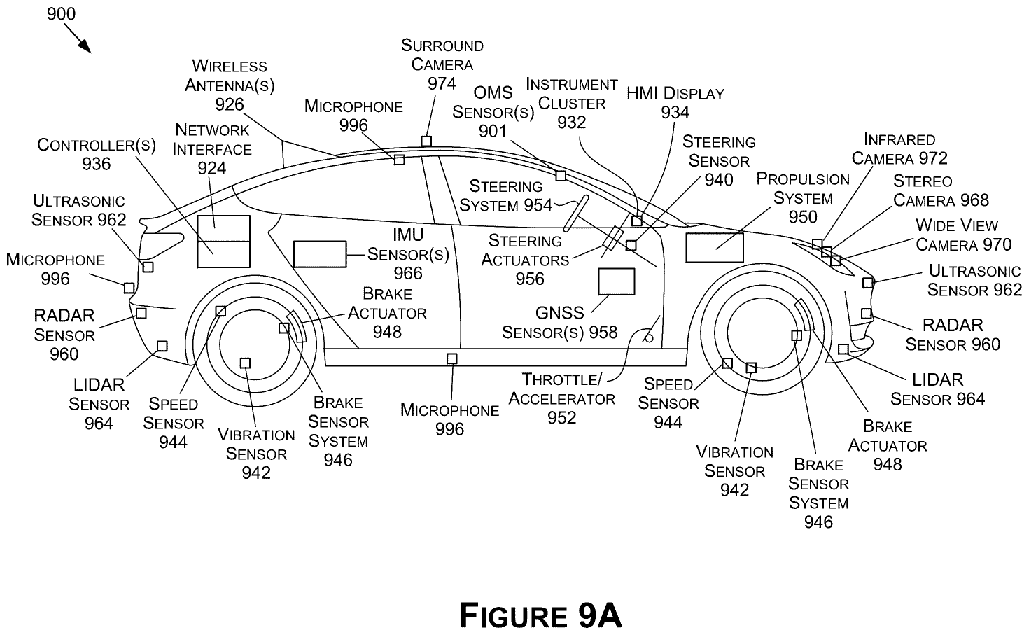

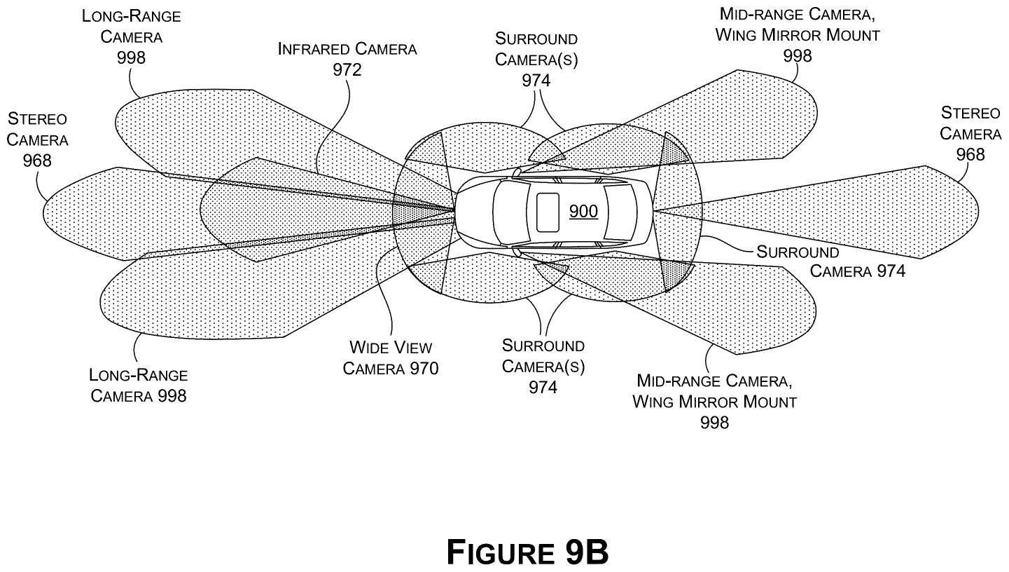

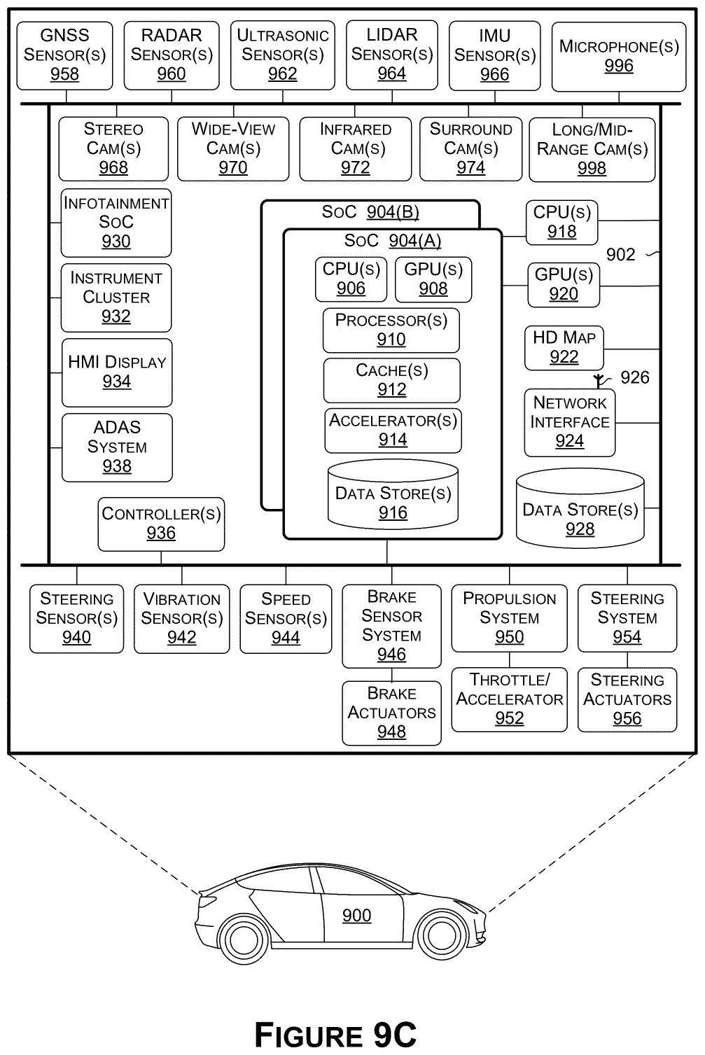

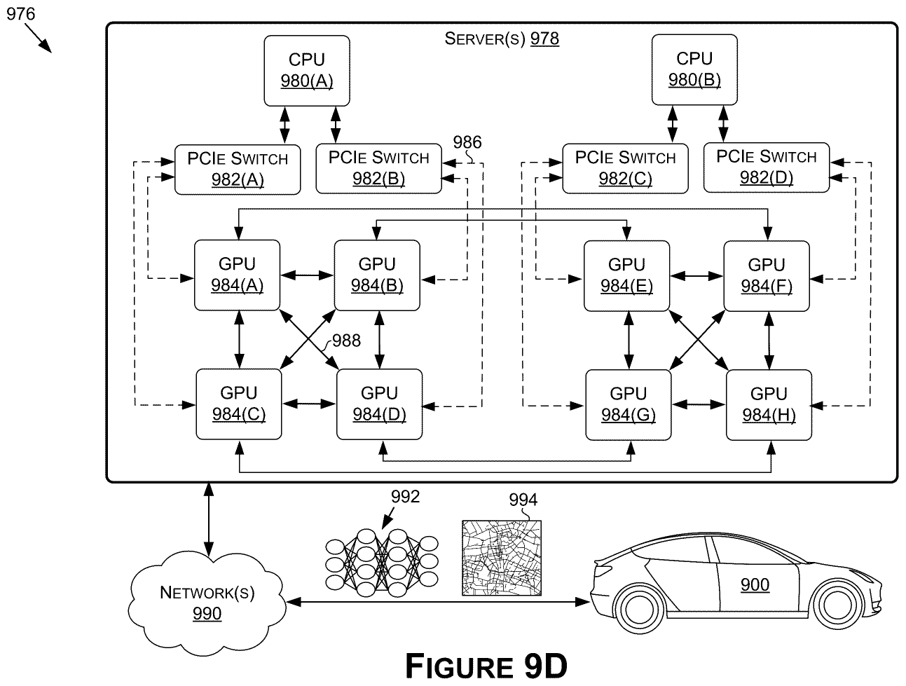

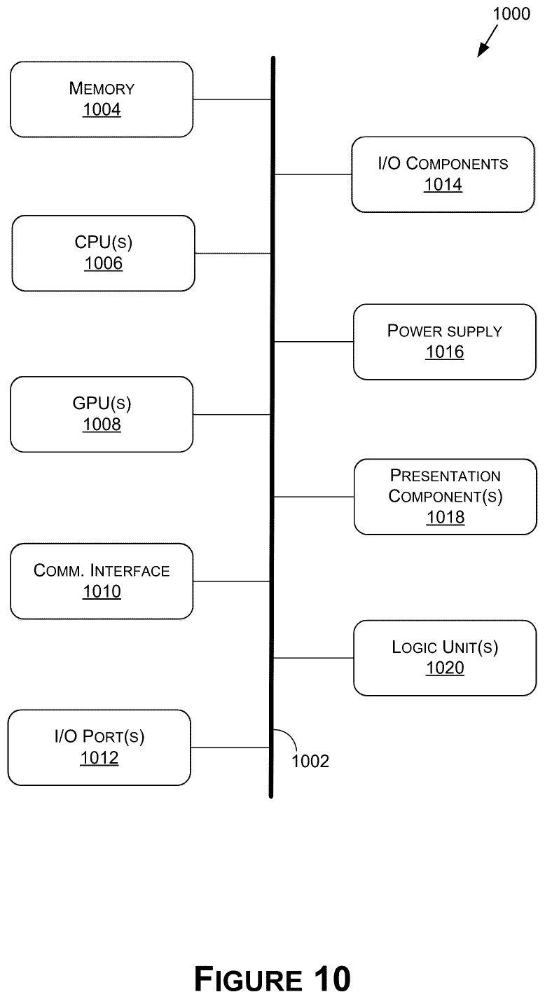

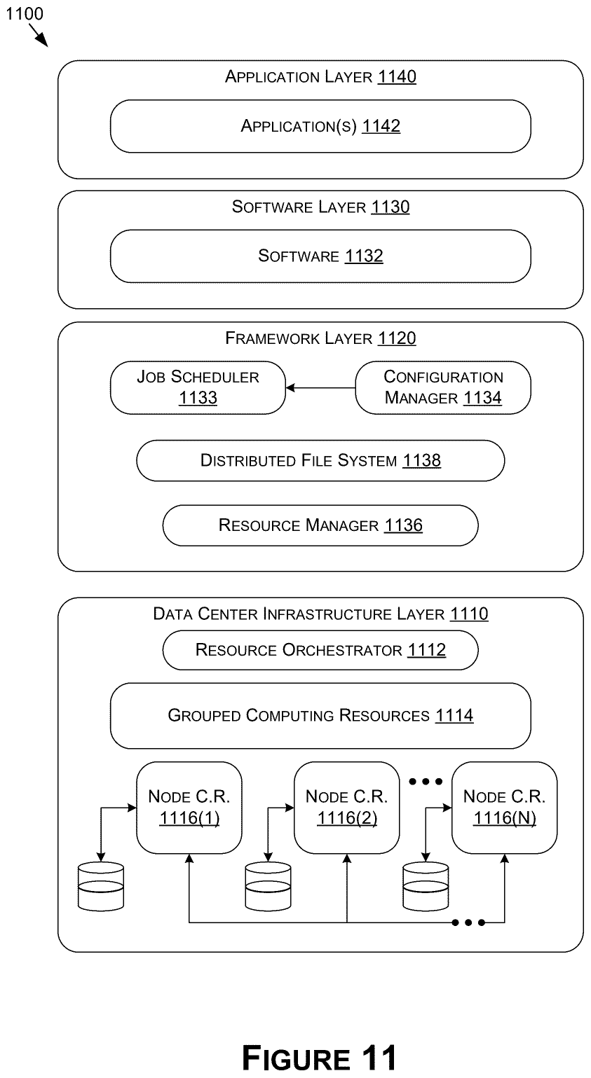

With reference to FIG. 1, FIG. 1 is an example pipeline 100 (referred to as “pipeline 100”) for automatically optimizing and evaluating a parameterizable model, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

As a high level overview, the pipeline 100 is responsible for optimizing and/or evaluating one or more parameterizable models. The pipeline 100 includes a user interface component 102, input data 104, a gateway API 106, an optimization/evaluation scheduler and executor 108, a node job handler 110, tasks 112, 114, and 116, storage 120, a federated optimization dashboard 122, a federated optimization service 124, job description 126, and dashboard information 130.

FIG. 1 illustrates an embodiment in which automated optimization and evaluation occurs across various compute nodes based on ingesting user input 104. At a first time, the user interface component 102 (e.g., a browser or Command Line Interface (CLI)) receives user input 104. The user input 104 includes a scenario, one or more Key Performance Indicators (KPIs), user data, and configuration data. A “scenario” as described herein refers to a user instruction that defines a sequence of actions associated with optimization and/or evaluation of a parameterizable model. In an illustrative example, a user may issue, at a CLI, a scenario script that outlines a sequence of actions that the self-driving car model must perform, along with the parameters being adjusted and the data recorded at each step as follows—step 1—the simulated self-driving car starts in an urban environment, where the parameters are speed limit, acceleration profile, distance to nearest obstacle. The data recorded is virtual vehicle speed, distance traveled, obstacles detected.

Per step 2 (another action in the sequence of actions), the car navigates a lane change maneuver, where the parameter is lane change speed, lane change distance, turn signal timing. The data that is recorded may be lane change success, time taken for lane change, distance from nearby vehicles. Per step 3, the car approaches and navigates through an intersection, where the parameters are intersection approach speed, stopping distance, and decision-making threshold. The data recorded may be intersection traversal time, successful lane selection, and detection of traffic signals.

Per step 4, the user specifies that the car finds and parks in an available parking spot, where the parameters include parking spot detection sensitivity, parking maneuver precision, distance from curb. The recorded data may be parking success, time taken to park, proximity to other vehicles or obstacles.

The “user data” of the input 104 may be any suitable data, such as type of model user will optimize and evaluate, sensor profile, or the like. A sensor profile refers to a set of parameters or characteristics that describe the behavior and properties of a sensor. Sensor profiles may be used in modeling and simulation to represent the response of various sensors to different stimuli or inputs. These parameters may include sensitivity, noise characteristics, resolution, dynamic range, response time, and other relevant properties that define how the sensor interacts with its environment. For example, with respect to the 4-step scenario illustrated above, the user may provide a sensor profile for a virtual LIDAR model, which is range, angular resolution, scan rate, accuracy, field of view (FOV), operating wavelength, and noise characteristics.

The configuration data within the input 104 includes any suitable settings and specifications that the user can define to customize the behavior and parameters of the evaluation and optimization process within the framework. These configurations help tailor the framework's operation to specific requirements and preferences. For example, one configuration includes number of steps for optimization. This specifies the maximum quantity of steps or iterations to be performed during the optimization process. This can help control the duration or complexity of the optimization procedure. Another configuration specified by the user is number of cluster nodes. In other words, the user can specify the quantity of nodes in a cluster that will be utilized for distributed processing, potentially speeding up the optimization (and/or evaluation) process by parallelizing computations across multiple nodes.

Another configuration may include parameter bounds. This defines the range or constraints for the parameters that are subject to optimization. Setting parameter bounds helps guide the optimization algorithm to search within a meaningful range of values. Consider an example scenario where embodiments are optimizing the parameters of a machine learning model for image classification tasks. In this context, parameter bounds could refer to the acceptable range or constraints for the values of certain parameters within the model. For instance, some embodiments may optimize the learning rate parameter for a neural network model using a gradient descent-based optimization algorithm. The learning rate determines the step size at each iteration of the optimization process. If the learning rate is too small, the optimization process may be slow. If the learning rate is too large, the process may oscillate or diverge. In this example, parameter bounds for the learning rate could be defined as follows: minimum learning rate: 0.001 and maximum learning rate: 0.1. This means that during the optimization process, the algorithm will only consider learning rates within the range of 0.001 to 0.1. Values outside of this range will not be explored. Setting parameter bounds in this way helps guide the optimization algorithm to search within a reasonable and meaningful range of values, preventing it from trying impractical or invalid values. Parameter bounds ensure that the optimization process remains efficient and effective by constraining the search space to values that are likely to yield good results, thus avoiding wasteful exploration of irrelevant or harmful parameter configurations.

Another example of user-specific configuration includes workflow. Workflow specifies whether the framework should perform validation, optimization, or both. This allows users to choose the desired workflow based on their current objectives.

After the user specifies one or more of these data within the input 104, the input is then passed to the gateway API 106. The gateway API 106 refers to an intermediary layer that sits between clients (e.g., client applications that include the user interface component 102) and backend services or systems, such as the components 108, 110, and 124. The gateway API 106 thus acts as a single entry point for accessing multiple services.

The job scheduler service 108 (e.g., NVIDIA's FARM MICROSERVICE) is generally responsible for scheduling jobs indicated in the user input 104, taking into account various compute nodes. In some embodiments, the job scheduler service 108 enables, via the node job handler 110 (e.g., FARM JOBS MICROSERVICE) efficient resource utilization by sharing computational resources across multiple machines or compute nodes. This ensures optimal performance and scalability. For example, users submit a scenario indicated in tasks 112, 114, and/or 116 to a Farm Queue (e.g., the node job handler 110). The Farm Queue manages the task queue and assigns them to available Farm Agents. Each Farm Agent runs on a specific compute node (e.g., a machine). There may thus be multiple Farm Agents, each of which run on a given compute node. Farm Agents continuously check the Farm Queue for pending tasks. When a task (e.g., 112) becomes available, the Farm Agent picks it up for execution. Farm Agents allocate resources (CPU, GPU, memory) based on the task requirements. If a node has multiple GPUs, the Farm Agent can distribute tasks across them. The Farm Agent executes the task on the assigned node.

A “task” as described herein refers to a specific computational or data processing activity that is executed within the framework for automatic validation, benchmarking, and/or optimization of parameterizable models. These tasks are fundamental components of the workflow orchestrated by the framework and serve various purposes, such as model training, parameter optimization, data validation, benchmarking, or orchestration of validation workflows. For example, a parameter optimization task focuses on finding the optimal values for the parameters of a model to maximize its performance. It may involve iterative optimization algorithms such as gradient descent or genetic algorithms. Conversely, in some embodiments, a data validation task validates the performance of a model against a set of Key Performance Indicators (KPIs) using recorded data. It ensures that the model behaves as expected and meets predefined quality standards. A benchmarking task compares the performance of a given model against standard benchmarks or reference models. It helps assess the effectiveness and competitiveness of the model in relation to existing solutions.

Once completed, the result of the task is sent back to the Farm Queue. Resource sharing ensures efficient utilization of available nodes. If one node is busy, the Farm Queue or node job handler 110 assigns tasks to less loaded nodes. Multiple users can submit tasks to the Farm Queue. Farm Agents handle tasks from different users concurrently. Compute nodes can be added or removed dynamically. For example, during peak rendering times, additional nodes can be added to speed up the process. In some embodiments, the job scheduler 108 is infrastructure-agnostic. This allows it to run on workstations, bare-metal servers, or cloud platforms like Kubernetes, or any other architecture.

In FIG. 1, task 112 may be scheduled to be performed on compute node 1. Task 114 may be scheduled to be performed on compute node 2. And task 116 may be scheduled to be performed on compute node 3. After scheduling by the job scheduler service 108, the tasks are consolidated via the aggregated output 118 and stored to storage 120 (e.g., Random Access Memory (RAM), disk, or storage array, such as a Storage Area Network (SAN)).

The federated optimization service 124 (e.g., EVOLVE MICROSERVICE) then accesses the aggregated output 118 in order to generate a federated job description 126. The federated optimization service 124 is generally responsible for generating a description that indicates how one or more compute nodes will optimize parameters during the received tasks. For example, the federated optimization service 124 may generate the federated description 126, which describes how federated learning will occur via the process of initialization, distribution of initial model parameters to participating compute nodes, local model training, model updates, and global model update distortion, and the like, as described in more detail below. The federated optimization dashboard service 122 (e.g., EVOLVE DASHBOARD MICROSERVICE) is generally responsible for generating or causing presentation (e.g., at a user device of an administrator) of optimization schedules and KPI values as determined by the federated optimization service 124.

Various embodiments then pass the federated job description 126 back through the gateway API 106, which then goes to the job scheduler service 108 and the node job handler 110 so that these components may modify jobs or tasks to be performed according to how the federated optimization service 124 instructs different nodes to engage in optimization. The Gateway API 106 is further responsible for generating the dashboard information 130, which then gets passed back to the user interface component 102 so that a user device displays corresponding information, such as real-time values as they occur throughout the entire process of optimization and/or evaluation (e.g., parameter values, such as weights, and how they are changed over various epochs). For example, the dashboard information 130 may KPI values over various time slices or epochs, sensor data over various time slices, parameter values over various time slices or epochs, scenario data, and the like.

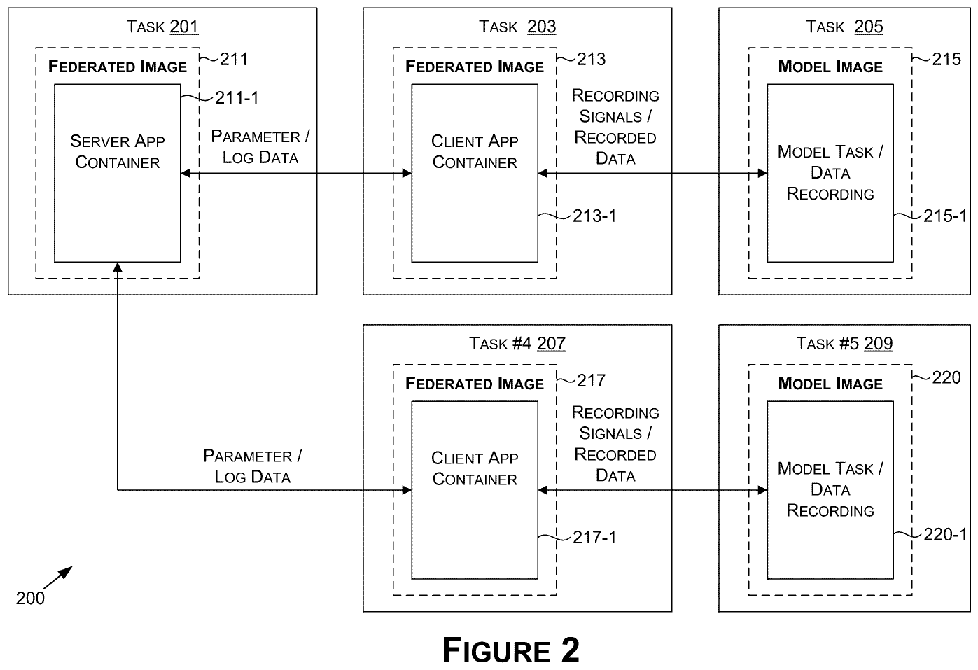

FIG. 2 is a block diagram illustrating how different tasks are performed via local and global optimization and evaluation, according to some embodiments. In some embodiments, the same task can be run on a single compute node or multiple compute nodes depending on how the job scheduler service 108 and the node job handler 110 scheduled the jobs. In some embodiments, each task 201, 203, 205, 207, and 209 represents modules and functionality performed on a distinct compute node, of multipole compute nodes in a distributed computing environment.

FIG. 2 includes different tasks 201 (e.g., representing the task 112 of FIGS. 1), 203, 205, 207, and 209. Each task includes or is associated with a particular image, such as a federated image, and other data. For example, the task 201 includes a federated image 211 (e.g., an EVOLVE IMAGE). In some embodiments any federated image described herein is a docker container responsible for federated optimization. A “docker container” as described herein is a lightweight, standalone, executable package that contains everything needed to run a piece of software, including the code, runtime, system tools, libraries, and settings. It is built from a Docker image, which is essentially a snapshot of a file system (e.g., the federated optimization service 124) that includes the necessary configuration to run an application. Containers share the host system's (e.g., a compute node's) kernel and resources, which reduces overhead compared to traditional virtual machines. There may be multiple docker containers per host.

The server app container 211 is generally responsible for performing global optimization and global validation, as described herein. For example, the server app container 211 may aggregate optimal parameters and results from each compute node and send out an average of the optimal parameters to the different compute nodes in a distributed environment.

The task 203 includes the federated image 213, which includes the client app container 213-1. The client app container 213-1 is generally responsible for performing local optimization and/or validation, as described herein as well as launching the model image 215 (e.g., a model container). After running these local operations, the client app container passes its updated parameter values and/or log data to the server app container 211-1, as illustrated in FIG. 2. The task 205 includes a model image 215, which includes the model task/data recording 215-1. A “model image” refers to a pre-packaged representation of a parameterized model that encapsulates not only the model architecture but also its parameters, dependencies, and configurations in a standardized and portable format. Similar to how Docker images encapsulate an application's code, dependencies, and configurations, a model image bundles together all the necessary components of a model, including the model architecture, trained parameters, preprocessing steps, and any additional dependencies required for inference. Just like Docker images can be deployed and run consistently across different environments, model images ensure portability of machine learning models across various platforms, compute nodes, and infrastructures. This allows for seamless deployment and execution of models in diverse computing environments, from local machines to cloud-based servers. In some embodiments, such model images facilitate scalable deployment of models by providing a lightweight and efficient representation that can be easily deployed and scaled across multiple compute nodes of a distributed systems.

The model task/data recording module 215-1 carries out the actual recording and/or collecting tasks specified by the user in the input 104. Such recorded data (e.g., sensor measurement readings by a virtual LiDAR) is passed to the client app container 213-1 so that the client app container 213-1 optimizes and/or validates such recorded data, as illustrated in FIG. 2.

The task 207 includes its own federated image 217 and runs its own client app container 217-1. The client app container 217-1 likewise performs local optimization and/or validation and launches the model image 220. The model task/data recording 220 sends its or recording data to the client app container 217-1, as illustrated in FIG. 2. The client app container 217-1 also sends its parameter/log data to the server app container 211-1.

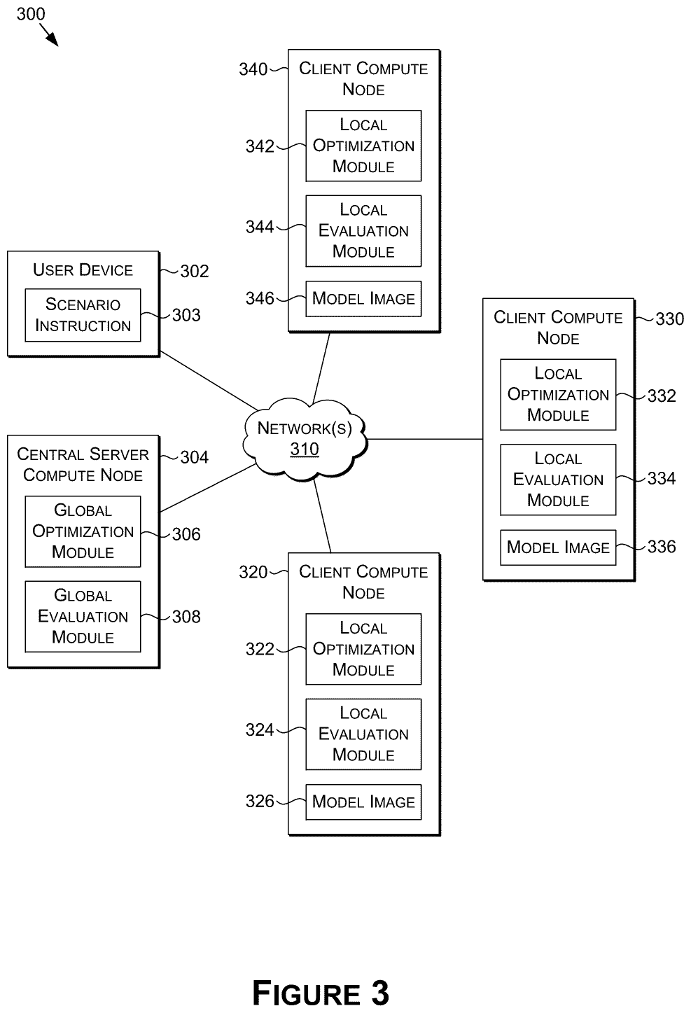

FIG. 3 is a block diagram of a distributed system architecture 300 (referred to as “system 300”), according to some embodiments. In some embodiments, one or more components within FIG. 1 and/or FIG. 2 represents one or more components of the system 300. For example, in some embodiments the central server compute node 304 represents or contains the functionality of the server app container 211-1 of FIG. 2 and/or the federated optimization service 124 of FIG. 1. In some embodiments, each of the client compute nodes 320, 330, and 340 represent or host a particular client app container, such as 213-1 or 217-1. In some embodiments, each of the model images 326, 336, and 346 represent the model image 215 or 220 of FIG. 2. It is understood that although the system 300 is illustrated in a specific type and quantity of compute nodes, any quantity and type may exist. For example, there may be more client compute nodes and more central server compute nodes. In some embodiments, the central server compute node 304 and one or more of the client compute nodes 320, 330, and/or 340 represent logic or software modules located within a same physical hardware host. In other words, a client and server can be hosted on a same computing device. In other embodiments, each of the compute nodes represent individual and distinct hardware computing devices (e.g., individual cloud nodes of a cloud computing architecture).

The distributed system architecture 300 is a computing paradigm in which multiple independent computing devices (e.g., “compute nodes”) work together as a unified system to perform a task or execute a program. Unlike traditional centralized systems where all processing occurs on a single machine, distributed systems distribute the workload across multiple machines connected via the network(s) 310. This architecture offers several advantages, including improved scalability, fault tolerance, and performance. In a distributed system, each individual computer or instance is referred to as a “compute node.” These compute nodes can vary in terms of their hardware specifications, operating systems, and geographical locations. Compute nodes communicate with each other over a network to collaborate on tasks (e.g., the tasks 112, 114, and 116) and share resources. In some embodiments, the compute nodes 304, 320, 330, and 340 represent a “cluster,” which is a group of interconnected compute nodes that work together to perform computing tasks.

At a first time a user formulates the scenario instruction 303 (and/or any of the input data 104) at a CLI or browser of the user device 302 (e.g., a mobile phone, desktop, etc.). The central server compute node 304 then takes, as input, the scenario instruction 303, and responsively sends out an initial parameter to every client compute node-compute nodes, 320, 330, and 340. Each client compute node then performs local optimization and evaluation on their corresponding model images (as described in more detail below), and passes their optimization and/or evaluation data (e.g., the parameters/log data as described with respect to FIG. 2) back to the central server compute node 304 so that the central server compute node 304 may perform global optimization (e.g., federated learning) via the global optimization module 306 and global evaluation (e.g., benchmarking and/or validation), as described in more detail below.

In some embodiments, some or each of the compute nodes 304, 320, 330, and 340 represent distinct hardware hosts, such as different computers. Alternatively, in some embodiments some or each compute nodes represents a virtual instance, such as a virtual machine or container (e.g., one or more of which are hosted on a single hardware host).

Each local optimization module in 322, 332, and 342 is generally responsible for performing local optimization, as described in more detail below. Each of the local evaluation modules 324, 334, and 344, is responsible for performing local evaluation (e.g., local benchmarking and/or local validation), as described in more detail below. In some embodiments, the model images 326, 336, and 346 together represent an image of the same parameterizable model (e.g., a sensor-based model that predicts LiDAR data), except that each of the model images are initialized or initially contain different parameters and/or different KPIs are used to validate and/or benchmark the corresponding models. Alternatively, in some embodiments, the model images 326, 336, and 346 represent different layers of the same model. For example the model image 326 may include various input and intermediate layers, such as convolutional and max pooling layers of a CNN (and no output layers), whereas the model image 336 may include an output layer, such as a dense layer (e.g., a fully connected layer) of a CNN. A dense layer is a type of layer that is fully connected, meaning that each neuron in the dense layer is connected to every neuron in the previous layer. Each connection between neurons has a learned weight and bias associated with it.

In some embodiments, communication between compute nodes is achieved through message passing protocols such as TCP/IP, UDP, or HTTP over the network(s) 310. The compute nodes may send messages to each other to exchange data, coordinate activities, and synchronize their operations. Communication can be synchronous or asynchronous, depending on the requirements of the system 300.

In some embodiments, the system 300 allows for the sharing of resources such as processing power, memory, storage, and input/output devices (e.g., virtual and/or hardware-based) across multiple compute nodes. This enables efficient utilization of resources and facilitates collaboration between nodes to accomplish tasks that may require more resources than any single node can provide.

One benefit of distributed systems is scalability. By adding more compute nodes to the system 300, it is possible to increase the system 300's capacity to handle larger workloads and accommodate more users. Distributed systems can scale horizontally by adding more compute nodes, vertically by upgrading existing nodes, or both.

In some embodiments, the system 300 is fault tolerant in that it is designed to be resilient in the face of failures. Since the system 300 includes multiple independent nodes, a failure in one compute node does not necessarily disrupt the entire system 300. Fault tolerance mechanisms such as replication, redundancy, and distributed consensus protocols help ensure the system 300 remains operational even in the presence of failures.

In some embodiments, the system 300 includes load balancing algorithms to distribute incoming requests or tasks evenly across multiple compute nodes to prevent any single compute node from becoming overwhelmed. This helps maximize resource utilization, minimize response times, and improve system performance.

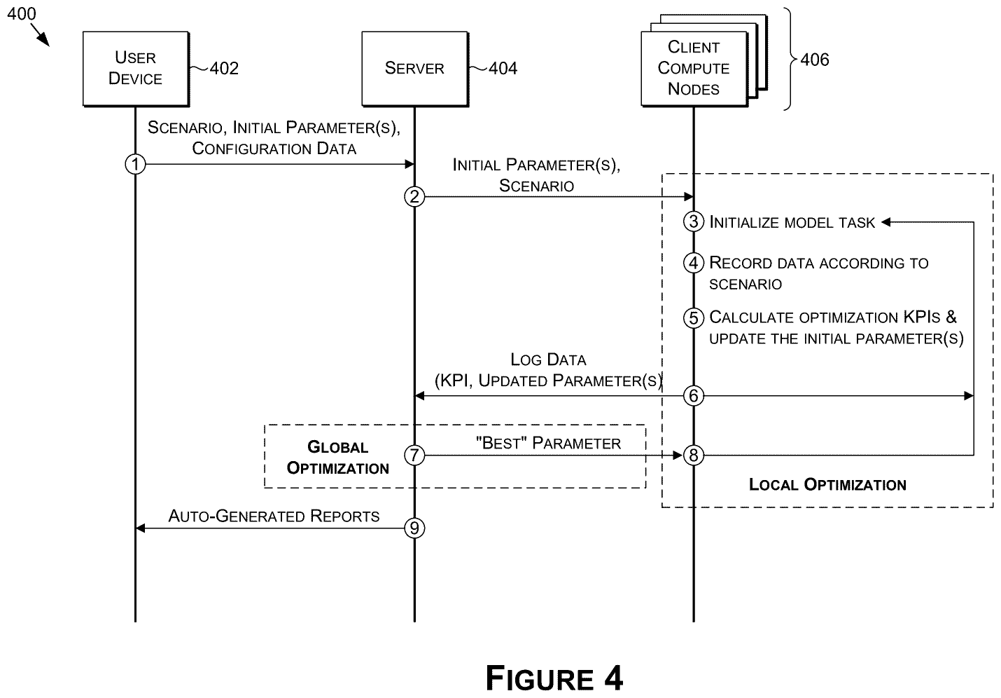

FIG. 4 is a sequence diagram illustrating how a user device, server, and client compute nodes work together to perform local and global optimization, according to some embodiments. In some embodiments, the user device 402 represents the user device 302 of FIG. 3. In some embodiments, the server 404 represents the central server compute node 304 of FIG. 3. In some embodiments, the client compute nodes 320, 330, and 340 of FIG. 3 are included in the client compute nodes 406 of FIG. 4. In some embodiments, both server 404 and a client, such as any of the client compute nodes 406 can run on the same computing device. In some embodiments, the server 404 is on a different compute node relative to the other client compute nodes 406.

At step 1, the user device transmits a scenario, initial parameter(s), and configuration data (e.g., number of steps to be taken for optimization, number of compute nodes to speed up optimization, parameter bounds, and workflow type (e.g., optimization or validation)) to the server 404. In some embodiments, a client application of the user device 402 initially includes a data loader that first formats the user scenario, initial parameter(s), and configuration data. A “data loader” as described herein reads recorded data into a known format. A data loader is responsible for loading and preparing datasets for use in training, validation, or testing of models. Data loaders are essential for handling various data formats, preprocessing data, and efficiently feeding data into models during training or evaluation. For example, the input 104 may include a dataset of images containing handwritten digits (0-9) called the MNIST dataset. Each image is represented as a matrix of pixel values, and each image is associated with a corresponding label indicating the digit it represents. The data loader for the MNIST dataset would perform data loading, data transformation, batching, shuffling, and iterating.

The data loader first reads the image files and their corresponding labels from disk into memory. It ensures that the images and labels are properly paired and organized for further processing. Since neural networks typically expect input data in a specific format, the data loader performs any necessary transformations on the raw data. For example, it may resize the images to a standard size, normalize the pixel values to a specific range (e.g., 0 to 1), and convert the data into tensors, which are the fundamental data structure used by many deep learning frameworks. To improve efficiency and exploit parallelism during training, the data loader in some embodiments divides the dataset into smaller batches of images and labels. Each batch contains a fixed number of samples, such as from 16 to 128 or more, depending on hardware constraints and the size of the dataset. To prevent the model from learning patterns specific to the order of the data, the data loader in some embodiments shuffles the batches randomly before each epoch (complete pass through the dataset). This ensures that the model encounters data samples in different orders during training, leading to better generalization. In some embodiments, the data loader provides an iterator interface that allows the training algorithm to iterate over the batches of data sequentially. At each iteration, the training algorithm processes one batch of input data, computes the corresponding predictions using the model, calculates the loss (error), and updates the model parameters through backpropagation.

At step 2, the server 404 then transmits the initial parameter(s) and the scenario to each of the client compute nodes 406. In some embodiments, the server 404 transmits different/unique initial parameters to each client compute nodes. For example, where there are multiple parameters specified by the user, the server 404 transmits a first parameter to a first client compute node in 406 and transmits a second parameter to a second client compute node in 406. In these embodiments, every node could search in a different parameter space. Accordingly, some embodiments try to get the “best” parameter by distributing work/parameters among client compute nodes.

In other embodiments, the same initial parameters are sent to all of the client compute nodes 406. This ensures that each client compute node starts with the same initial parameter values before performing local optimization tasks. For example, the server 404 distributes an initial set of neural network parameters (weights and biases) to all client compute nodes 406 participating in the optimization task. Each client compute node receives the same initial parameter values from the server 404. The client compute nodes 406 use these initial parameters to initialize their local neural network models before starting the optimization process. Throughout the optimization process, each client compute node independently updates its local model parameters based on its subset of the training data and communicates the updated parameters and performance metrics back to the server 404 for aggregation and analysis. By sending out the same initial parameter set to every client compute node, the server 404 ensures consistency and synchronicity in the optimization process across all client compute nodes 406, facilitating collaborative optimization towards a common objective.

At steps 3 through 6, local optimization occurs at each client compute node (e.g., as performed by the local optimization modules 322, 332, and 342). At step 3, each client application (e.g., client app container 213-1) of each client compute node in 406 sets up a local optimizer and initializes a model task (e.g., DRIVESIM). For example, some embodiments optimize the parameters of a machine learning model that predicts vehicle trajectories in various driving scenarios using data collected from a driving simulation software. The client application running on a computing node sets up a local optimization algorithm, such as gradient descent, to adjust the parameters of the model. It initializes the model task by configuring the driving simulation software to simulate different driving scenarios.

At step 4, each client application of each client compute node records data according to the user-provided scenario. For instance, the client application first updates the initial parameter(s) and ticks start of scenario, including data recording. For example, each client application adjusts or updates the parameters of the model being optimized based on the current iteration of the optimization process. These parameters could include weights, biases, learning rates, or any other configurable settings that influence the behavior of the model. Regarding the “tick,” (a signal or trigger) each client application initiates the start of a scenario step, which represents a specific segment or phase of the overall optimization process. This step may involve executing a predefined set of actions, such as simulating a driving scenario, processing a batch of data, or performing a computational task. Within the scenario step, the client application records relevant data that captures the current state of the system or environment. This data may include input features, model predictions, performance metrics, or any other information necessary for analyzing the behavior or performance of the model. For example, embodiments may optimize a machine learning model for autonomous vehicle navigation in urban environments. Each client application running on a respective client compute node updates the parameters of the model based on the current iteration of the optimization algorithm. It then initiates the start of a scenario step, representing the simulation of a specific driving scenario within an urban environment. During the scenario step, the client application records various data, such as the vehicle's position, velocity, sensor readings, and environment observations. This recorded data serves as input for evaluating the performance of the model and guiding further parameter updates in subsequent iterations of the optimization process.

Next, and as part of step 4, each model task (e.g., the model images 326, 336, and 346) receives such tick, starts the scenario step and records data. For example, in the context of autonomous vehicle navigation, this step could involve simulating a portion of the driving route or executing a specific maneuver, such as making a turn or navigating an intersection. The scenario step represents a discrete unit of action within the overall scenario, and it may involve various operations, computations, or interactions with the environment. This recorded data may include information such as vehicle trajectory, sensor readings, environmental conditions, and any other factors that influence the vehicle's navigation. The model task then loads the recorded data, communicates known data format to the corresponding client application and ticks a “recording done” flag. By specifying the data format, the model task provides essential information to the client application about how to parse and analyze the recorded data effectively. This flag serves as an indication that the recorded data is ready for further processing or analysis by the client application or other components of the system.

At step 5, each client compute node calculates one or more optimization KPI(s) and updates the initial parameter(s) (e.g., via training a model). In some embodiments, each client compute node calculates a unique or different KPI. In alternative embodiments, each client compute node calculates the same KPI. The local optimizer within each client application computes various KPIs based on the data recorded during the scenario step. These KPIs serve as metrics to assess the performance of, for example, the autonomous navigation system. Optimization KPIs evaluate the relative improvement achieved by optimization algorithms or processes in enhancing the model's performance. They measure the effectiveness and efficiency of optimization efforts in iteratively refining the model.

Examples of different optimization KPIs include the following: Convergence Rate—rate at which the optimization algorithm converges towards an optimal solution. It indicates how quickly the algorithm reaches a stable solution. Convergence Accuracy indicates the degree of closeness between the optimized solution obtained by the algorithm and the true optimal solution. It measures the accuracy of convergence achieved by the optimization process. Improvement in Objective Function Value indicates the reduction in the value of the objective function being optimized (e.g., loss function, cost function) over optimization iterations. It quantifies the improvement in model performance achieved through optimization. Reduction in Error Metrics decrease in error metrics (e.g., mean squared error, classification error rate) between the optimized model predictions and ground truth data. It indicates the reduction in prediction errors achieved by optimization. Speed of Convergence refers to the time taken for the optimization algorithm to converge towards an optimal solution. It measures the efficiency of the optimization process in reaching convergence within a specified time frame. Stability of Optimization Process KPI refers to consistency and robustness of the optimization process across multiple iterations or variations. It assesses the reliability of the optimization algorithm in producing consistent results. Efficiency of Resource Utilization refers to the degree to which computational resources (e.g., CPU time, memory usage) are effectively utilized during the optimization process. It evaluates the efficiency of resource allocation and utilization in optimization tasks.

Examples of KPIs in this context could include metrics such as: accuracy of the virtual vehicle's trajectory prediction, collision avoidance performance, efficiency of route planning and execution, and smoothness of driving behavior. After calculating the KPIs, the local optimizer analyzes these metrics to determine how effectively the current parameters of the model are performing. If the KPIs indicate suboptimal performance or deviations from desired objectives (e.g., high collision rates, inaccurate trajectory predictions), the local optimizer adjusts the model parameters accordingly. In some embodiments, parameter adjustments involve fine-tuning the weights of the neural network, updating control policies, modifying decision-making algorithms, or making other changes to improve the performance of the autonomous navigation system.

In an illustrative example, suppose the KPIs computed by the local optimizer reveal that the autonomous vehicle frequently deviates from its intended path during simulated driving scenarios. In response to these KPIs, the local optimizer may adjust the parameters of the vehicle's trajectory prediction model to improve its accuracy and reduce deviations. For example, it may increase the weight assigned to historical trajectory data, adjust the learning rate of the model, or introduce regularization techniques to prevent overfitting.

At step 6, each of the client compute nodes 406 then transmit their own log data (i.e., the KPI and updated parameter) back to the server 404. Each client compute node simultaneously keeps performing local optimization (e.g., steps 3 through 6) until number of steps threshold is met for local optimization is met and/or optimization tolerance (e.g., a loss value via computing loss function) was met. For example, after a first epoch or round of training, each client compute node 406 transmits an updated parameter, which continuously occurs after each epoch until a model is fully trained. At step 7, the server 404 responsively computes and transmits the “best” parameter to each of the client compute nodes 406 based on aggregating, in any suitable way, each of the received updated parameters from each of the client compute nodes 406. This process involves sharing performance metrics (KPIs) and model parameters between the clients and the server to coordinate global optimization efforts. Such computations and transmission of step 7 corresponds to the “global optimization” as described herein (e.g., as performed by the global optimization component).

In an illustrative example of the computations at step 7, suppose one client application has computed KPIs indicating high accuracy in trajectory prediction but low efficiency in collision avoidance. It sends these KPI values along with its corresponding model parameters to the server 404. The server 404 coordinates the global optimization process by collecting KPIs and parameters from all client applications. It waits for all client applications to transmit their data, ensuring that it has received information from every client compute node participating in the optimization task. Once the server 404 has collected KPIs and parameters from all of the client compute nodes 406, it aggregates this information to form a comprehensive view of the optimization process. It may analyze the collected data to identify trends, patterns, or areas requiring improvement across different client nodes. Based on the aggregated results and optimization objectives, the server 404 determines the best set of parameters that optimize the performance of the autonomous navigation system globally. It sends these optimized parameters back to the respective client applications. For example, if the aggregated data indicates that a particular set of parameters consistently leads to improved performance across multiple nodes, the server 404 selects those parameters as the best choice.

In an illustrative example, suppose the server 404 receives KPIs and parameters from multiple client applications. After aggregating the data, it identifies that certain parameters consistently result in better trajectory prediction and collision avoidance performance across all client compute nodes 406. The server 404 then selects these optimized parameters and distributes them back to all of the client compute nodes 406 for further use in the optimization process. At step 8, each of the client compute nodes 406 then take such “best” parameter and then incorporate it into additional rounds of local optimization (steps 3 through 6) in a loop until overall number of iterations or optimal tolerance was reached (e.g., loss via a loss function is under a threshold).

At step 9, the server 404 auto-generates one or more reports and transmits them back to the user device 402. For example, a Large Language Model (LLM) may be used to generate a summary of the results, findings, and insights obtained from the optimization process. These reports may consolidate key information, metrics, visualizations, and analysis outcomes into a structured document for easy review and presentation. For example, after completing a series of optimization iterations or evaluation runs, the server 404 automatically generates a report summarizing the performance of the autonomous navigation system. This report may include: metrics such as accuracy of trajectory prediction, collision rates, efficiency of route planning, and adherence to traffic rules. The report may further include details on the optimized parameters selected for the model based on the optimization process. The report may include graphs and representations of data and performance trends, such as line graphs showing changes in performance metrics over iterations or bar charts comparing different parameter settings. The report may further include insights derived from the analysis of collected data, highlighting strengths, weaknesses, and areas for improvement in the autonomous navigation system. The report may further include recommendations-suggestions for further optimization steps, adjustments to model parameters, or areas of focus for future development efforts.

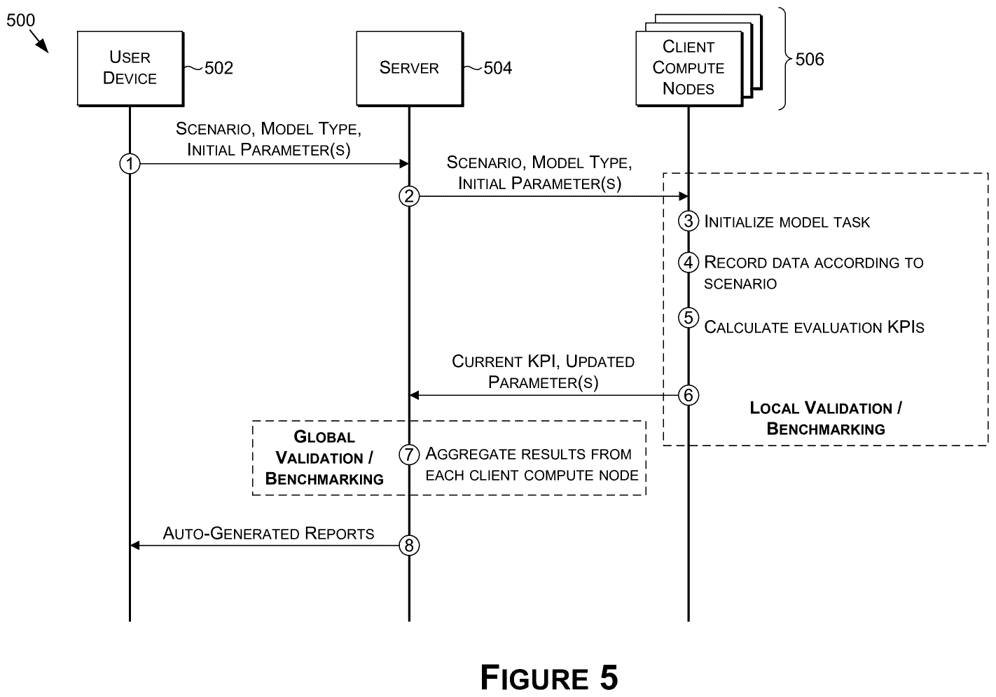

FIG. 5 is a sequence diagram illustrating how a user device, server, and client compute nodes work together to perform local and global evaluation (e.g., benchmarking and/or validation), according to some embodiments. In some embodiments, the user device 502 represents the user device 302 of FIG. 3, and/or the user device 402 of FIG. 4. In some embodiments, the server 404 represents the central server compute node 304 of FIG. 3, and/or the server 404 of FIG. 4. In some embodiments, the client compute nodes 320, 330, and 340 of FIG. 3 are included in the client compute nodes 506 of FIG. 5. In some embodiments, the client compute nodes 506 represent the same set of client compute nodes 406 of FIG. 4. In other words, in some embodiments, FIG. 4 and FIG. 5 may be combined together such that the components can perform both local optimization and validation/benchmarking, as well as global optimization and validation/benchmarking.

At step 1, the user device 402 transmits a scenario, model type, an initial parameter(s) to the server 504. Regarding the model type, for example, the user may provide their version of a known model, such as a specific radar model for DriveSim. FIG. 5 may use this model to calculate pre-defined KPIs for different existing scenarios to benchmark/validate the provided model per scenario and KPI, as described below.

Per step 2, the server transmits the scenario, model type (e.g., a model type ID that identifies the model type), and the initial parameter(s) to each of the client compute nodes 506. At steps 3 through 6, each of the client compute nodes 506 then perform local validation/benchmarking. In some embodiments, steps 3 through 5 are identical to steps 3 through 5 of FIG. 4. That is, each client compute node first initializes the model task (step 3), then records data according to the user-provided scenario (step 4), and then calculates one or more KPIs at step 5 (except that the KPIs are evaluation KPIs). In some embodiments, the KPIs at step 5 of FIG. 5 may be suited to benchmarking and/or validation and may therefore be different relative to optimization KPIs as described with respect to FIG. 4. Benchmarking KPIs, for example, evaluate the absolute performance of a model against a standard or reference, often in comparison with existing models or ground truth data. They provide insights into how well the model performs in absolute terms. For example, suitable benchmarking KPIs include Accuracy-percentage of correctly detected objects or obstacles in radar sensor data compared to ground truth, error rate in estimating the position, velocity, or trajectory of detected objects, precision-proportion of true positive detections among all positive detections, recall-proportion of true positive detections among all actual positives (i.e., ground truth), false positive rate-percentage of falsely detected objects or obstacles in radar sensor data relative to all detections, false negative rate-percentage of missed detections of actual objects or obstacles in radar sensor data relative to all actual objects, and the like. Other examples include detection range of a sensor (e.g., maximum distance at which the radar sensor can reliably detect objects or obstacles), localization error, velocity estimation error, response time, or processing time. This differs from optimization KPS, as illustrated in step 5 of FIG. 4.

Validation KPIs on the other hand evaluate the generalization and reliability of a model on unseen data to ensure that the model performs well in real-world scenarios beyond the training or benchmarking dataset. The following are different examples of validation KPIs. Accuracy (percentage of correctly predicted outcomes on the validation dataset. It measures the overall correctness of the model's predictions), Precision and Recall, F1 Score (Harmonic mean of precision and recall. It provides a balance between precision and recall, especially when dealing with imbalanced datasets), Area Under the ROC Curve (AUC-ROC) (Measure of the model's ability to discriminate between positive and negative classes across different threshold values. It assesses the model's overall classification performance), Mean Squared Error (MSE) (Average of the squared differences between the model's predicted values and the actual values in regression tasks. It quantifies the average prediction error of the model), Mean Absolute Error (MAE) (Average of the absolute differences between the model's predicted values and the actual values in regression tasks. It provides a measure of the average magnitude of errors in predictions.), Classification Error Rate (percentage of misclassified instances in the validation dataset. It measures the proportion of incorrect predictions made by the model), Confusion Matrix (matrix that summarizes the performance of a classification model by comparing predicted and actual class labels. It provides insights into the model's performance across different classes), Cross-Validation Scores (Average performance scores obtained through cross-validation techniques (e.g., k-fold cross-validation). It assesses the model's stability and generalization ability across multiple validation subsets), Bias and Variance (Analysis of bias (underfitting) and variance (overfitting) in the model's predictions on the validation dataset. It helps identify the trade-off between model complexity and generalization performance).

At step 6, each of the client compute nodes 506 transmit their current KPI (which may be the same or different) and updated parameter to the server 504. The purpose is to provide real-time updates to the server 504 regarding the performance of the models being evaluated or benchmarked across different scenarios or iterations. For example, in the context of autonomous vehicle simulation, suppose multiple client applications are running simulations with different radar models. As the simulations progress, each client continuously logs KPIs such as detection accuracy, false positive rate, and localization error, along with the corresponding model parameters (e.g., neural network weights, configuration settings). These log data are transmitted to the server 504 in real-time, allowing it to monitor the performance of each radar model across various scenarios and make informed decisions dynamically.

At step 7, the server 504 then aggregates the results from each of the client compute node 7, which is indicative of global validation and/or benchmarking (e.g., as performed by the global evaluation module 308 of FIG. 3). Therefore, the server 505 evaluates the aggregated data to make global assessments or validations across all clients/client compute nodes 506. The Server 504 waits to receive data from all of the client compute nodes 506 before proceeding with the aggregation and validation process. Once data from all clients is collected, the server aggregates the KPIs and parameters across all of the client compute nodes 506 to perform a comprehensive analysis. For example, in some embodiments the server 504 calculates summary statistics, compares performance metrics across different models or scenarios, and identify patterns or trends in the aggregated data. The server then uses this aggregated information to perform global validation assessments, such as comparing the performance of different radar models or identifying common issues across simulations.

In yet another example of global evaluation of step 7, consider an online marketplace that uses a distributed system to collect and analyze user behavior data from multiple client applications (e.g., mobile apps, web browsers). The marketplace operator wants to perform global validation of user engagement across different regions. Each of the client compute nodes 506 collects user engagement metrics, such as page views, click-through rates, and conversion rates, from users in a specific geographic region. These client applications continuously send the collected metrics to the server 504. The server 504 serves as the global validator responsible for aggregating and analyzing user engagement data from all regions. The server 504 waits until it receives data from all client applications/client compute nodes 506 across different regions. Once data from all clients is collected, the server 504 aggregates the user engagement metrics, including page views, click-through rates, and conversion rates, from each region. The server 504 calculates summary statistics (e.g., average page views per user, overall click-through rate) and identifies trends or patterns in user behavior across regions. Using the aggregated data, the server 504 performs global validation of user engagement metrics across the entire online marketplace. It compares user engagement levels between regions, identifies regions with higher or lower engagement rates, and assesses the overall performance of the online marketplace. Based on the global validation results, the marketplace operator can make informed decisions to optimize user experience, target marketing efforts, or allocate resources effectively. For example, if the global validation reveals that certain regions have lower conversion rates, the operator may focus on improving user engagement strategies or offering targeted promotions in those regions.

At step 8, the server 504 auto-generates one or more reports and sends them to the user device 502. For example, upon receiving data from all of the client compute nodes 506, the server 504 automatically generates comprehensive reports summarizing the performance evaluation results for each model. These reports include detailed analyses of model performance metrics, comparison of different model configurations or algorithms, and insights into the effectiveness of each model in its predictions. Visualizations such as charts, graphs, and tables are included in some embodiments to present the performance evaluation findings effectively. The reports may also contain recommendations for further model refinement or optimization based on the observed performance trends and analysis.

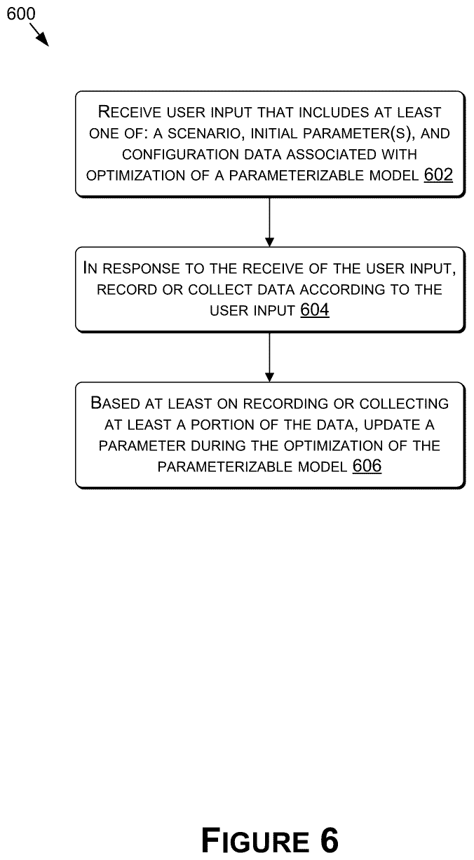

FIG. 6 is a flow diagram of an example method 600 for optimizing a parameterizable model, according to some embodiments. In some embodiments, the method 600 is performed by the central server compute node 304 and/or a client compute node (e.g., 320 of FIG. 3) of FIG. 3. Each block of method 600 (and/or 700), described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 600 is described, by way of example, with respect to the client compute nodes 406 of FIG. 4. However, these methods may additionally or alternatively be executed by any one system, or any combination of systems, including, but not limited to, those described herein.

Per block 602, some embodiments receive user input that includes at least one of: a scenario, one or more initial parameters, or configuration data associated with optimization of a parameterizable model. For example, the scenario may include a user instruction that defines a sequence of actions associated with the optimization, where at least one action, of the sequence of actions, represents a collection or recording task associated with the optimization of the parameterizable model. Examples of such user instruction is described by the “scenario” as part of the input in step 1 of FIG. 4. Other examples include the scenario in the user input 104 of FIG. 1. In an illustrative example of such scenario, in the aerospace industry, engineers often conduct flight simulations to evaluate the performance of aircraft under various conditions. These simulations involve a series of predefined steps or actions representing different flight scenarios. Each scenario is designed to test specific aspects of the aircraft's performance, such as maneuverability, stability, and fuel efficiency. A scenario in this instance may be defined as a sequence of flight maneuvers and conditions that simulate real-world flight scenarios. Each scenario includes parameters such as altitude, airspeed, throttle setting, and control inputs. For example, a scenario could simulate a sequence of actions including takeoff, climb to cruising altitude, banking maneuvers, descent, and landing. During the flight simulation, data recording steps are executed to capture various flight parameters and performance metrics. These steps may involve recording data such as altitude, airspeed, engine performance, control surface positions, and environmental conditions (e.g., wind speed, temperature).

In some embodiments, such “configuration data” included in the user input may include any suitable data as described herein, such as a quantity of compute nodes to be used for the optimization (e.g., user states to limit the compute nodes to 5 for optimization), an indication of whether optimization or validation is to be performed (e.g., optimization in this context), a current parameter to be evaluated by the parameterized model, and a quantity of steps associated with the optimization. In some embodiments, such quantity of steps refers to or is indicative of the number of iterations or epochs the optimization algorithm will run. For example, it may control the number of training epochs for each hyperparameter combination during grid search. Other examples of configuration data includes learning rate (e.g., [0.001, 0.01, 0.1]), batch size: (e.g., [32, 64, 128]), dropout rate: (e.g., [0.2, 0.4, 0.6]), or the like.

Per block 604, in response to the receiving of the user input, some embodiments record or collect data according to the user input (e.g., the scenario). For example, using the illustration above, some embodiments record data such as altitude, airspeed, engine performance, control surface positions, and environmental conditions (e.g., wind speed, temperature) during takeoff, climb, and cruising altitude of a simulated airspace model. In some embodiments, block 604 represents step 4 of FIG. 4. In some embodiments, block 604 alternatively represents an “instruction” to perform such data recording or collecting or otherwise a signal that includes the initial parameter(s) or scenario, as illustrated by step 2 of FIG. 4. In other words, block 604 may represent step 2 performed by the server 404 in some embodiments.

Per block 606, based at least on recording or collecting at least a portion of the data (per block 604), some embodiments update a parameter during the optimization of the parameterizable model. In some embodiments block 606 represents local and/or global optimization as described herein. Examples of block 606 are described with respect to the “update initial parameter(s)” portion of step 5 in FIG. 4. For example, using the flight simulation illustration above, during the climb phase, the aircraft's speed parameter needs to be adjusted to maintain a specified climb rate while reaching the desired altitude. The flight simulation model interacts with the simulation environment to dynamically adjust the aircraft's speed parameter based on predefined criteria and inputs. For example, the simulation model may incorporate feedback from control inputs, environmental conditions (e.g., air density, wind speed), and aircraft performance characteristics to determine the optimal speed for climbing. During the climb phase of the flight scenario, the simulation model updates the aircraft's speed parameter to achieve the desired climb rate and altitude. This may involve increasing or decreasing the throttle setting, adjusting the pitch angle, and managing other control surfaces to control the aircraft's speed.

In some embodiments, the process 600 additionally includes calculating an optimization performance metric (e.g., an optimization KPI as described with respect to step 5 of FIG. 4). And based at least in part on calculating the performance metric and the update the parameter during the optimization, some embodiments then transmit, to a first compute node of a plurality of compute nodes, the parameter and the optimization performance metric as a part of the optimization. Examples of this are described with respect to steps 5 and 6 of FIG. 4, where a client compute node in 406 calculates an optimization KPI and updates the updated initial parameter(s) for step 6 and then transmits the log data to the server 404 at step 6. In an illustrative example, a client compute node may transmit the calculated convergence accuracy value ϵ=0.001, as well as a value for an updated parameter. In some embodiments, the process 600 alternatively or additionally includes “receiving” such optimization performance metric and updated parameter, instead of just “transmitting” such data.

In response to such transmitting, to the first compute node of the plurality of compute nodes, the updated parameter, as part of the method 600 some embodiments receive, from the first compute node, a set of values. Some embodiments may then change the parameter according to the set of values based at least on the first compute node having aggregated parameter values from the plurality of compute nodes. An example of such functionality is described with respect to step 8 of FIG. 4 where a client compute node in 406 updates a parameter based on having received the “best” parameter from the server 404 via step 7. In an illustrative example of the first node having aggregated parameter values, the server 404 may have received a learning rate from each client compute node and the server 404 responsively calculates a mean of each learning rate received from the client compute nodes 406. The server 404 then transmits such mean to all the client compute nodes 406, which is a new starting point (e.g., training epoch) for all parameters.

In some embodiments, the method 600 includes recording or collecting at least a portion of the data for at least a second action, of the sequence of actions, according to the user instruction based at least on the update of the parameter during the optimization task. In other words, the update of the parameter influences an action. For instance, suppose we have a neural network model that is being trained using a stochastic gradient descent (SGD) optimization algorithm. In each iteration of the training process, various embodiments update the model's parameters based on a small batch of training data. First, embodiments start by initializing the neural network model with random weights and biases. During each iteration of the training loop, various embodiments: (1) randomly select a mini-batch of training examples from the dataset; (2) compute the gradients of the loss function with respect to the model parameters using the selected mini-batch; (3) update the model parameters (weights and biases) (e.g., step 6 of FIG. 4) using the computed gradients and the learning rate, according to the SGD algorithm. As part of the training process, some embodiments record various data related to the model's performance and behavior. For example, some embodiments record optimization performance metrics such as the training loss, accuracy, and validation loss after each training iteration. These data are recorded using the updated parameters of the model, which have been adjusted based on the mini-batch of training data processed in that iteration.

In an illustrative example, in one training iteration, some embodiments update the weights and biases of the neural network model based on a mini-batch of 32 training examples. After updating the parameters, some embodiments compute the training loss and accuracy using the updated model. The recorded data for this iteration, such as the training loss and accuracy, are associated with the updated parameters of the model that were used during the computation. This ensures that the recorded data accurately reflect the performance of the model with the most recent parameter updates. In this example, the data recorded in each training step are associated with the updated parameters of the optimizer, which represent the current state of the model after processing a mini-batch of training data. This ensures that the recorded data accurately reflect the performance and behavior of the model throughout the training process.

In some embodiments, the method 600 includes causing presentation of data (e.g., the auto-generated report, as described with respect to step 9 of FIG. 4). For example, some embodiments (e.g., the client compute nodes 406 and/or the server 404) cause presentation, at a user device, of at least one of, one or more parameter values, one or more optimization performance metrics, the data, or the user instruction.

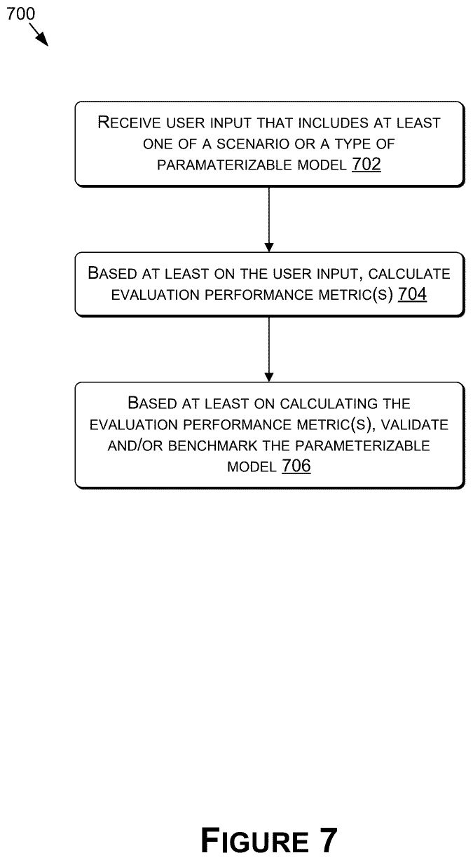

FIG. 7 is a flow diagram of an example method 700 for validating and/or benchmarking a parameterizable model, according to some embodiments. In some embodiments, the method 700 is performed by the central server compute node 304 and/or a client compute node (e.g., 320 of FIG. 3). Per block 703, some embodiments receive user input that includes at least one of a scenario, or a type of a parameterizable model. For example, some embodiments receive, via a CLI, a string that specifies a specific type of machine learning model. For instance, Linear Regression, where parameters include coefficients for each feature. Logistic Regression, where parameters include coefficients for each feature and an intercept. Support Vector Machines (SVM), where parameters include the choice of kernel function and regularization parameter. Decision Trees, where parameters include tree depth, minimum samples per leaf, and split criterion. Random Forests, where parameters include the number of trees, maximum tree depth, and number of features considered for each split. Neural Networks, where parameters include the architecture (number of layers, number of neurons per layer), activation functions, learning rate, and regularization strength.

In another example, the user may alternatively or additionally specify a type of simulation model. For example, Physics-based Models, where parameters include physical constants, material properties, initial conditions, and boundary conditions. In another example, the user-specified type of parameterizable model may include Control Systems, such as PID Controllers, where parameters include proportional, integral, and derivative gains. In yet another example, the user-specified models may include optimization models, such as Linear Programming Models, where the parameters include objective function coefficients and constraints. Other examples include Image Processing Models (e.g., object detection models, where parameters include anchor box sizes, aspect ratios, and confidence thresholds. Other examples include Natural Language Processing Models (e.g., Large Language models (LLMs), Long Short Term Memory (LSTM) models), where parameters include number of layers, attention heads, and dropout rates.

Per block 705, based at least in part on the user input, some embodiments calculate one or more evaluation performance metrics. Examples of such calculations include the calculation of the evaluation KPIs at step 5 of FIG. 5. For example, some embodiments use or dictionary, look-up table, hash map, or other key-value pair data structure to map the particular user-specified type of model to a corresponding key in the data structure to derive corresponding values, which indicate the specific evaluation KPIs used for that model. In an illustrative example, the user may specific that they are validating an “LLM.” Accordingly, using this string, particular embodiments match such string to a corresponding “LLM” key string in a lookup table. Various embodiments then read the values in the same entry. For example, in some embodiments, such values are one or more of the following, Perplexity (measures how well the model predicts a sequence of words. Lower perplexity indicates better language understanding), Word Error Rate (WER) (measures the percentage of incorrectly predicted words compared to the ground truth), Semantic Similarity (measures the similarity between predicted and reference sentences using semantic embeddings or similarity metrics), Cloze Test Accuracy (measures how accurately the model predicts missing words in a given context), Named Entity Recognition (NER) Accuracy (measures the accuracy of identifying named entities in text), Sentiment Analysis Accuracy (measures the accuracy of predicting sentiment labels (positive, negative, neutral) for given text samples), Bias Metrics (measures the presence of biases in the model's predictions, such as gender bias, racial bias, or socio-economic bias), Inference Time (measures the time taken to generate responses or predictions for given inputs). Accordingly, in response to reading one or more of these values, some embodiments perform the corresponding validation KPIs on a parameterizable model output (e.g., a final prediction of the model after the model has been trained).

Per block 707, based at least on calculating the evaluation performance metric(s), some embodiments validate and/or benchmark the parameterizable model. In some embodiments, block 707 represents local and/or global validation and/or benchmarking as described herein. Consider a situation in which a text generation model, such as a Large Language Model (LLM), has been generated and we want to validate its performance using various KPIs. Various embodiments first define specific evaluation tasks to assess different aspects of the text generation model, such as fluency, coherence, and relevance. Tasks may include generating text completions for given prompts, generating responses to conversational prompts, or generating summaries for given documents.

Based on the defined evaluation tasks, various embodiments select relevant KPIs to measure the model's performance (e.g., as described above with respect to the key-value pair data structure). For example, various embodiments may choose perplexity, coherence scores, and human judgment scores as KPIs to assess language understanding and generation quality.

Continuing with this LLM example, a dataset containing evaluation examples for each evaluation task is prepared, along with reference outputs or ground truth for comparison. The dataset covers diverse language patterns, topics, and styles to provide a comprehensive evaluation of the model, in some embodiments. Various embodiments then feed the evaluation data into the text generation model and generate outputs for each evaluation example. For each generated output, various embodiments compute the selected KPIs to quantify the model's performance. For perplexity, some embodiments calculate the perplexity score for each generated sequence using the model's language model probabilities and compare it against the ground truth. For coherence scores, some embodiments use automated metrics such as coherence or readability scores to quantify the logical flow and coherence of generated text.

In some embodiments, each individual client compute node aggregate the KPI scores obtained from evaluating multiple examples across different evaluation tasks. This provides an overall assessment of the model's performance across various dimensions. Various embodiments interpret the KPI scores to understand which aspects of the model's performance need improvement and which aspects are satisfactory. Various embodiments compare the performance of the text generation model against baseline models or existing state-of-the-art models using the same evaluation tasks and KPIs. This helps benchmark the model's performance relative to existing approaches. Based on the analysis and interpretation of results, some embodiments iteratively refine the text generation model to improve its performance on identified weaknesses. This may involve adjusting model architecture, hyperparameters, or training procedures based on insights gained from the evaluation. By following these steps, various embodiments can systematically validate and benchmark a text generation model based on performing one or more KPIs, providing insights into its strengths, weaknesses, and areas for improvement.

In some embodiments, the process 700 includes recording or collecting data according to at least one action of a sequence of actions indicated in the scenario of the user input of block 703. For example, as described with respect to FIG. 5, a client compute node may perform step 4. And based at least in part on the calculating the one or more evaluation performance metrics and recording or collecting the data according to the at least one action, some embodiments transmit, to a first compute node of a plurality of compute nodes, the one or more evaluation performance metrics. Put another way, in response to at least one of the validation or benchmarking of the parameterizable model (at block 707), some embodiments transmit, to a first compute node of a plurality of compute nodes, the one or more evaluation performance metrics. Examples of this are described with respect to one of the client compute nodes 506, which performs step 6 to transmit the current KPI and updated parameter to the server 504. Although this step is described with respect to the client compute nodes 506, in additional or alternative embodiments, the server 504 receives (instead of “transmits”) such current KPI and/or updated parameter.

In response to the transmit (and or receipt), to/by the first compute node of the plurality of compute nodes, the one or more evaluation performance metrics, some embodiments (e.g., a client compute node) receive (and/or the sever 504 generates), from the first compute node (e.g., the server 504), an indication (e.g., a flag) of whether there has been global validation based at least on the first compute node having aggregated performance metrics from the plurality of compute nodes. For example, the server 504 may have aggregated different or unique performance metrics and/or a different scenario from each of the client compute nodes 506. The server 504, for example, may receive different/unique KPIS from each client compute nodes (e.g., the server 504 receives a first KPI and/or first scenario from a first client compute node and a second KPI and/or a second scenario from a second client compute node).

The server 504 may then aggregate these evaluation KPIs and their corresponding values. For example, after completing location validation tasks, each client compute node reports its validation results, including the computed evaluation performance metrics, back to the server 504. The server 504 waits to receive validation results from all distributed client compute nodes 506 before aggregating the results. Once all client compute nodes 506 have submitted their validation results, the server 504 aggregates the results to generate a comprehensive validation report. For example, the server 504 may aggregate the results by calculating the average accuracy, average precision, average recall, and other metrics across all of the client compute nodes 506 to obtain a consolidated view of model performance. In some embodiments aggregating the results alternatively or additionally includes consolidating or wrapping each of the individual evaluation KPIS from each of the client compute nodes in a report without doing any further calculations.

Based on the aggregated validation results, the server 504 generates a global validation report summarizing the overall performance of the model across all distributed client compute nodes 506. The report may include statistics, visualizations, and insights derived from the aggregated validation metrics.

Stakeholders may use such global validation report to assess the model's performance and make informed decisions about further improvements or adjustments. Feedback from the validation report may lead to iterative refinement of the model or validation process to address identified issues or shortcomings. This aggregation process ensures that the global validation report reflects the collective validation efforts across all distributed client compute nodes and provides a unified perspective on model performance.

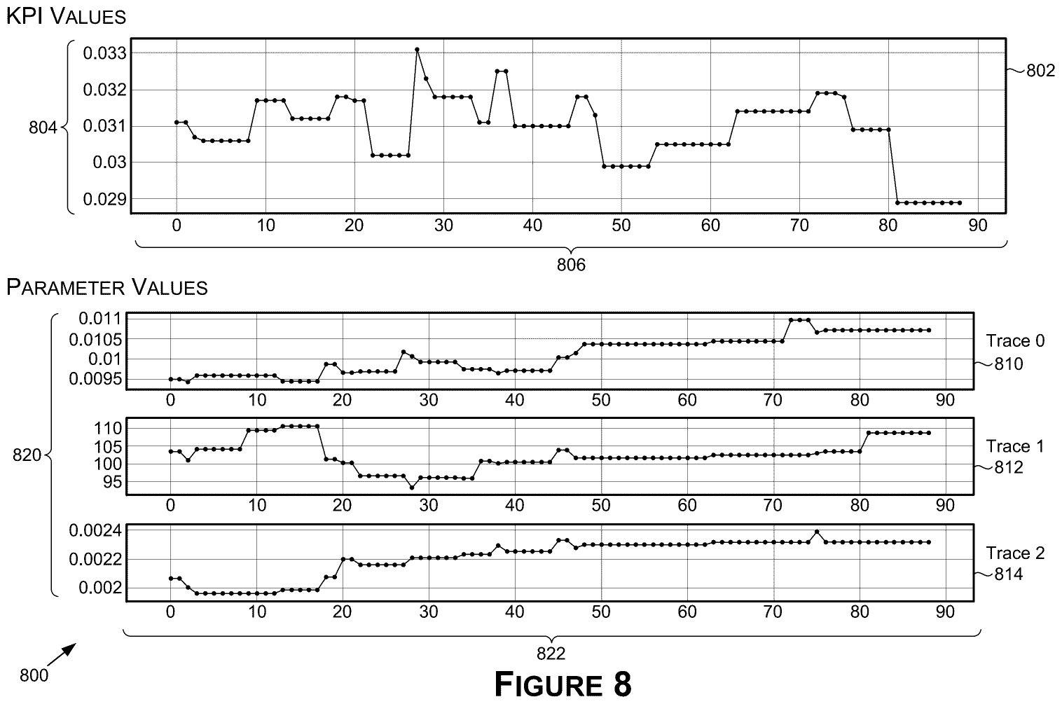

FIG. 8 illustrates a visualization 800 (e.g., a user interface) of KPI values and parameter values over optimization iterations, according to some embodiments. In some embodiments, the visualization 800 at least partially represents what is produced on the auto-generated reports at step 9 of FIG. 4 and/or step 8 of FIG. 5.

The visualization 800 includes a first line graph 800, where the Y-axis contains KPI values (e.g., optimization performance metrics or evaluation performance metrics), and the X-axis represents optimization iterations or parameter values. An “optimization iteration” as described herein may refer to any suitable iteration, such as a training epoch/round (e.g., “10” refers to 10 epochs), a sequence of timestamps or time periods (e.g., “10” refers to 10 minutes), and/or the like. The visualization 800 further includes a second set of line graphs 810, 812, and 814, which represent individual traces (e.g., parameters). A trace is a collection of data points, each representing a specific configuration of parameter values, its associated KPI values, and/or optimization iterations. Each data point in the trace corresponds to a distinct experiment, parameter, iteration, or evaluation of the parameterizable model. A trace represents the evolution or trajectory of the model's performance (KPI values) as the parameters are adjusted or optimized over time. During model optimization or validation processes, various embodiments record traces by logging parameter values and their corresponding KPI values at each iteration or experiment. Traces can be recorded for various purposes, such as monitoring model convergence, analyzing parameter sensitivity, or comparing different optimization algorithms. Y-axis 820 represents varying parameter values of three different parameters. The X-axis 822 represents different optimization iterations.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to allow the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to allow autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LiDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), one or more occupant monitoring system (OMS) sensor(s) 901 (e.g., one or more interior cameras), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

Cameras with a field of view that include portions of the interior environment within the cabin of the vehicle 900 (e.g., one or more OMS sensor(s) 901) may be used as part of an occupant monitoring system (OMS) such as, but not limited to, a driver monitoring system (DMS). For example, OMS sensors (e.g., the OMS sensor(s) 901) may be used (e.g., by the controller(s) 936) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation allowing any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 904 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LiDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 916 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to allow communication with peripherals, audio codecs, power management, and/or other devices. The SoC(s) 904 may be used to process data from cameras (e.g., connected over Gigabit Multimedia Serial Link and Ethernet), sensors (e.g., LiDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to allow wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated using the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LiDAR sensor(s) 964. The LiDAR sensor(s) 964 may be used for object and pedestrian detection, emergency braking, collision avoidance, and/or other functions. The LiDAR sensor(s) 964 may be functional safety level ASIL B. In some examples, the vehicle 900 may include multiple LiDAR sensors 964 (e.g., two, four, six, etc.) that may use Ethernet (e.g., to provide data to a Gigabit Ethernet switch).

In some examples, the LiDAR sensor(s) 964 may be capable of providing a list of objects and their distances for a 360-degree field of view. Commercially available LiDAR sensor(s) 964 may have an advertised range of approximately 900 m, with an accuracy of 2 cm-3 cm, and with support for a 900 Mbps Ethernet connection, for example. In some examples, one or more non-protruding LiDAR sensors 964 may be used. In such examples, the LiDAR sensor(s) 964 may be implemented as a small device that may be embedded into the front, rear, sides, and/or corners of the vehicle 900. The LiDAR sensor(s) 964, in such examples, may provide up to a 120-degree horizontal and 35-degree vertical field-of-view, with a 200 m range even for low-reflectivity objects. Front-mounted LiDAR sensor(s) 964 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 900. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may allow the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LiDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 900), while the 12V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. As such, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(D) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161 (N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more of the embodiments described below can exist alone or be combined in any manner. In an example embodiment, one or more processors comprise one or more processing units to: receive user input that specifies a type of parameterizable model; based at least on the user input that specifies the type parameterizable model, calculate one or more evaluation performance metrics corresponding to an implementation of the parameterizable model across a plurality of nodes of a distributing computing environment; and based at least on calculating the one or more evaluation performance metrics and the user input that specifies the type parameterizable model, perform at least one of validation or benchmarking of the parameterizable model.

In some embodiments, the user input further defines a sequence of actions associated with at least one of validation or benchmarking of the parameterizable model, at least one action of the sequence of actions, representing a collection or recording task associated with the a least one of validation or benchmarking, and wherein the one or more processing units are further to: based at least on the user input that defines the sequence of actions, record or collect data according to the at least one action of the sequence of actions; and based at least in part on the calculating the one or more evaluation performance metrics and recording or collecting the data according to the at least one action, transmit the one or more evaluation performance metrics to a first compute node of the plurality of compute nodes.

In some embodiments, the one or more processing units are further to: in response to at least one of the validation or benchmarking of the parameterizable model, transmit the one or more evaluation performance metrics to a first compute node of the plurality of compute nodes; and in response to transmission of the one or more evaluation performance metrics to the first compute node of the plurality of compute nodes, receive, from the first compute node, an indication of whether there has been global validation based at least on the first compute node having aggregated evaluation performance metrics from the plurality of compute nodes.

In some embodiments, the first compute node aggregates evaluation performance metrics from the plurality of compute nodes by receiving one or more Key Performance Indicators (KPI) from at least two of the plurality of compute nodes and presenting at least one KPI of the one or more KPIs in a report.

In some embodiments, the one or more evaluation performance metrics include one or more validation performance metrics and one or more benchmarking performance metrics, and wherein the one or more processing units are further to: perform both validation and benchmarking of the parameterizable model.

In some embodiments, the one or more processing units are further to: in response to validation or benchmarking the parameterizable model, automatically cause presentation of a report at a user device, the report including at least one of: a first visualization indicating changes in evaluation performance metrics over time, sensor data associated with the parameterizable model, or a user instruction.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system incorporating one or more virtual machines (VMs); a system implemented at least partially in a data center; or a system implemented at least partially using cloud computing resources.

In an embodiments, a system comprises one or more processing units to: receive user input that specifies at least one of: a type of parameterizable model or an identifier of one or more evaluation performance metrics; based at least on the user input, calculate the one or more evaluation performance metrics corresponding to an implementation of the parameterizable model across a plurality of compute nodes of a distributed computing environment; and based at least on calculating the one or more evaluation performance metrics and the user input, perform at least one of validation or benchmarking of the parameterizable model.

In some embodiments, the user input further defines a sequence of actions associated with at least one of validation or benchmarking of the parameterizable model, at least one action, of the sequence of actions, representing a collection or recording task associated with the a least one of validation or benchmarking, and wherein the one or more processing units are further to: based at least on the user input that defines the sequence of actions, record or collect data according to the at least one action of the sequence of actions; and based at least in part on the calculating the one or more evaluation performance metrics and recording or collecting the data according to the at least one action, transmit the one or more evaluation performance metrics to a first compute node of the plurality of compute nodes.

In some embodiments, he one or more processing units are further to: in response to at least one of the validation or benchmarking of the parameterizable model, transmit the one or more evaluation performance metrics to a first compute node of the plurality of compute nodes; and in response to transmission of the one or more evaluation performance metrics to the first compute node of the plurality of compute nodes, receive, from the first compute node, an indication of whether there has been global validation based at least on the first compute node having aggregated evaluation performance metrics from the plurality of compute nodes.

In some embodiments, the first compute node aggregates evaluation performance metrics from the plurality of compute nodes by receiving one or more Key Performance Indicators (KPI) from at least two of the plurality of compute nodes and presenting at least one KPI of the one or more KPIs in a report.

In some embodiments, the one or more evaluation performance metrics include one or more validation performance metrics and one or more benchmarking performance metrics, and wherein the one or more processing units are further to: perform both validation and benchmarking of the parameterizable model.

In some embodiments, the one or more processing units are further to: in response to validation or benchmarking the parameterizable model, automatically cause presentation of a report at a user device, the report including at least one of: a first visualization indicating changes in evaluation performance metrics over time, sensor data associated with the parameterizable model, or a user instruction.

In some embodiments, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system incorporating one or more virtual machines (VMs); a system implemented at least partially in a data center; or a system implemented at least partially using cloud computing resources.

In an embodiments, a method comprises: based at least on user input that specifies a type of parameterizable model implemented across a plurality of compute nodes of a distributed computing environment, performing local validation and/or benchmarking by calculating one or more evaluation performance metrics; in response to the performing local validation and/or benchmarking, transmitting the one or more evaluation performance metrics to a first compute node of the plurality of compute nodes; and in response to transmission of the one or more evaluation performance metrics to the first compute node of the plurality of compute nodes, causing the first compute node to aggregate one or more respective evaluation performance metrics from at least two compute nodes of the plurality of compute nodes.

In some embodiments, the user input further defines a sequence of actions associated with at least one of validation or benchmarking of the parameterizable model, at least one action of the sequence of actions representing a collection or recording task associated with the a least one of validation or benchmarking, and wherein the method further comprises: based at least on the user input that defines the sequence of actions, recording or collecting data according to the at least one action of the sequence of actions; and based at least in part on the calculating the one or more evaluation performance metrics and recording or collecting the data according to the at least one action, transmitting the one or more evaluation performance metrics to a first compute node of the plurality of compute nodes.

In some embodiments, the first compute node aggregates evaluation performance metrics from the plurality of compute nodes by receiving one or more Key Performance Indicators (KPI) from the at least two of the plurality of compute nodes and presenting at least one KPI of the one or more KPIs in a report.

In some embodiments, the one or more evaluation performance metrics include one or more benchmarking performance metrics, and wherein the method further comprising: performing benchmarking of the parameterizable model.

In some embodiments, the method further comprises: in response to validation or benchmarking the parameterizable model, automatically causing presentation of a report at a user device, the report including at least one of: a first visualization indicating changes in evaluation performance metrics over time, sensor data associated with the parameterizable model, or a user instruction.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system incorporating one or more virtual machines (VMs); a system implemented at least partially in a data center; or a system implemented at least partially using cloud computing resources.

What is claimed is:

1. One or more processors comprising one or more processing units to:
receive user input that specifies a type of parameterizable model;
based at least on the user input that specifies the type parameterizable model, calculate one or more evaluation performance metrics corresponding to an implementation of the parameterizable model across a plurality of nodes of a distributing computing environment; and
based at least on calculating the one or more evaluation performance metrics and the user input that specifies the type parameterizable model, perform at least one of validation or benchmarking of the parameterizable model.

2. The one or more processors of claim 1, wherein the user input further defines a sequence of actions associated with at least one of validation or benchmarking of the parameterizable model, at least one action of the sequence of actions, representing a collection or recording task associated with the a least one of validation or benchmarking, and wherein the one or more processing units are further to:
based at least on the user input that defines the sequence of actions, record or collect data according to the at least one action of the sequence of actions; and
based at least in part on the calculating the one or more evaluation performance metrics and recording or collecting the data according to the at least one action, transmit the one or more evaluation performance metrics to a first compute node of the plurality of compute nodes.

3. The one or more processors of claim 1, wherein the one or more processing units are further to:
in response to at least one of the validation or benchmarking of the parameterizable model, transmit the one or more evaluation performance metrics to a first compute node of the plurality of compute nodes; and
in response to transmission of the one or more evaluation performance metrics to the first compute node of the plurality of compute nodes, receive, from the first compute node, an indication of whether there has been global validation based at least on the first compute node having aggregated evaluation performance metrics from the plurality of compute nodes.

4. The one or more processors of claim 3, wherein the first compute node aggregates evaluation performance metrics from the plurality of compute nodes by receiving one or more Key Performance Indicators (KPI) from at least two of the plurality of compute nodes and presenting at least one KPI of the one or more KPIs in a report.

5. The one or more processors of claim 1, wherein the one or more evaluation performance metrics include one or more validation performance metrics and one or more benchmarking performance metrics, and wherein the one or more processing units are further to:
perform both validation and benchmarking of the parameterizable model.

6. The one or more processors of claim 1, wherein the one or more processing units are further to:
in response to validation or benchmarking the parameterizable model, automatically cause presentation of a report at a user device, the report including at least one of: a first visualization indicating changes in evaluation performance metrics over time, sensor data associated with the parameterizable model, or a user instruction.

7. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs);
a system incorporating one or more virtual machines (VMs);
a system implemented at least partially in a data center; or
a system implemented at least partially using cloud computing resources.

8. A system comprising one or more processing units to:
receive user input that specifies at least one of: a type of parameterizable model or an identifier of one or more evaluation performance metrics;
based at least on the user input, calculate the one or more evaluation performance metrics corresponding to an implementation of the parameterizable model across a plurality of compute nodes of a distributed computing environment; and
based at least on calculating the one or more evaluation performance metrics and the user input, perform at least one of validation or benchmarking of the parameterizable model.

9. The system of claim 8, wherein the user input further defines a sequence of actions associated with at least one of validation or benchmarking of the parameterizable model, at least one action, of the sequence of actions, representing a collection or recording task associated with the a least one of validation or benchmarking, and wherein the one or more processing units are further to:
based at least on the user input that defines the sequence of actions, record or collect data according to the at least one action of the sequence of actions; and
based at least in part on the calculating the one or more evaluation performance metrics and recording or collecting the data according to the at least one action, transmit the one or more evaluation performance metrics to a first compute node of the plurality of compute nodes.

10. The system of claim 8, wherein the one or more processing units are further to:
in response to at least one of the validation or benchmarking of the parameterizable model, transmit the one or more evaluation performance metrics to a first compute node of the plurality of compute nodes; and
in response to transmission of the one or more evaluation performance metrics to the first compute node of the plurality of compute nodes, receive, from the first compute node, an indication of whether there has been global validation based at least on the first compute node having aggregated evaluation performance metrics from the plurality of compute nodes.

11. The system of claim 10, wherein the first compute node aggregates evaluation performance metrics from the plurality of compute nodes by receiving one or more Key Performance Indicators (KPI) from at least two of the plurality of compute nodes and presenting at least one KPI of the one or more KPIs in a report.

12. The system of claim 8, wherein the one or more evaluation performance metrics include one or more validation performance metrics and one or more benchmarking performance metrics, and wherein the one or more processing units are further to:
perform both validation and benchmarking of the parameterizable model.

13. The system of claim 8, wherein the one or more processing units are further to:
in response to validation or benchmarking the parameterizable model, automatically cause presentation of a report at a user device, the report including at least one of: a first visualization indicating changes in evaluation performance metrics over time, sensor data associated with the parameterizable model, or a user instruction.

14. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs)
a system incorporating one or more virtual machines (VMs);
a system implemented at least partially in a data center; or
a system implemented at least partially using cloud computing resources.

15. A method comprising:
based at least on user input that specifies a type of parameterizable model implemented across a plurality of compute nodes of a distributed computing environment, performing local validation and/or benchmarking by calculating one or more evaluation performance metrics;
in response to the performing local validation and/or benchmarking, transmitting the one or more evaluation performance metrics to a first compute node of the plurality of compute nodes; and
in response to transmission of the one or more evaluation performance metrics to the first compute node of the plurality of compute nodes, causing the first compute node to aggregate one or more respective evaluation performance metrics from at least two compute nodes of the plurality of compute nodes.

16. The method of claim 15, wherein the user input further defines a sequence of actions associated with at least one of validation or benchmarking of the parameterizable model, at least one action of the sequence of actions representing a collection or recording task associated with the a least one of validation or benchmarking, and wherein the method further comprises:
based at least on the user input that defines the sequence of actions, recording or collecting data according to the at least one action of the sequence of actions; and
based at least in part on the calculating the one or more evaluation performance metrics and recording or collecting the data according to the at least one action, transmitting the one or more evaluation performance metrics to a first compute node of the plurality of compute nodes.

17. The method of claim 15, wherein the first compute node aggregates evaluation performance metrics from the plurality of compute nodes by receiving one or more Key Performance Indicators (KPI) from the at least two of the plurality of compute nodes and presenting at least one KPI of the one or more KPIs in a report.

18. The method of claim 15, wherein the one or more evaluation performance metrics include one or more benchmarking performance metrics, and wherein the method further comprising:
performing benchmarking of the parameterizable model.

19. The method of claim 15, further comprising:
in response to validation or benchmarking the parameterizable model, automatically causing presentation of a report at a user device, the report including at least one of: a first visualization indicating changes in evaluation performance metrics over time, sensor data associated with the parameterizable model, or a user instruction.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs)
a system incorporating one or more virtual machines (VMs);
a system implemented at least partially in a data center; or
a system implemented at least partially using cloud computing resources.
